(19) United States
(12) Patent Application Publication
(10) Pub. No.: US 2024/0219412 A1
(43) Pub. Date: Jul. 4, 2024

(54) ROBOTIC CONTROL FOR PARTICLE SAMPLING AND MONITORING

(71) Applicants: PARTICLE MEASURING SYSTEMS, INC., Boulder, CO (US); PHARMA INTEGRATION S.R.L., Siena (IT)

(72) Inventors: Giovanni SCIALÒ, Frascati (IT); Davide RECCHIA, Frascati (IT); Claudio BECHINI, Siena (IT)

(73) Assignees: PARTICLE MEASURING SYSTEMS, INC., Boulder, CO (US); PHARMA INTEGRATION S.R.L, Siena (IT)

(21) Appl. No.: 18/543,884

(22) Filed: Dec. 18, 2023

Related U.S. Application Data
(60) Provisional application No. 63/476,338, filed on Dec. 20, 2022.
(60) Provisional application No. 63/479,522, filed on Jan. 11, 2023.

(51) Int. Cl. G01N 35/00

(52) U.S. Cl. CPC G01N 35/00584

(57) ABSTRACT

Provided herein are systems and methods for sampling of controlled environments, including automated and/or robotically controlled sampling. The present systems and methods are useful for determining the presence of, quantity, size, concentration, viability, species or characteristics of particles, including viable biological particles, within a controlled environment. The described systems and methods may utilize rotational motion via robotics, automation and/or control systems to reduce, or eliminate, some or all of the steps carried out by human operators in traditional particle collection and/or analysis methodologies. The described systems and methods may rotational motion via robotics, automation and/or control systems to provide for particle sampling over time periods that are well-defined for an individual impactor and/or sequential sampling via a plurality of impactors.

### CROSS-REFERENCE TO RELATED APPLICATIONS

This application claims the benefit of priority to U.S. Provisional Patent Application No. 63/476,338, filed Dec. 20, 2022, and U.S. Provisional Patent Application No. 63/479,522, filed Jan. 11, 2023, each of which is hereby incorporated by reference in its entirety.

### INCORPORATION BY REFERENCE

The following references, each of which is incorporated herein in its entirety to the extent not inconsistent herewith, relate to particle sampling, analysis, automation and robotic control: U.S. Pat. No. 10,345,200, issued Jul. 9, 2019; U.S. Pat. No. 11,231,345, issued Jan. 25, 2022; U.S. Pat. No. 11,255,760, issued Feb. 22, 2022; and US Patent Publication No. US20210223273, published Jul. 22, 2021.

### BACKGROUND OF INVENTION

The invention is in the field of particle sampling, collection and analysis. The invention relates generally to systems and methods for robotic control, automation and handling for particle samplers and counters for characterizing particles in air and other gases in controlled environments including clean room environments and aseptic manufacturing environments.

Cleanrooms and clean zones are commonly used in a wide range of industries including microelectronics, semiconductors, pharmaceutical, biological and medical device manufacturing, cosmetics and food and beverages. For the semiconductor industry, for example, an increase in airborne particulate concentration can result in a decrease in fabrication efficiency, as particles that settle on semiconductor wafers will impact or interfere with the small length scale manufacturing processes. For the pharmaceutical industry, on the other hand, where this type of real-time efficiency feedback is lacking, contamination by airborne particulates and biological contaminants puts pharmaceutical products at risk for failing to meet cleanliness level standards established by the US Food and Drug Administration (FDA) and other foreign and international health regulatory agencies.

Standards for the classification of cleanroom particle levels and standards for testing and monitoring to ensure compliance are provided by ISO 14664-1 and 14664-2. Aerosol optical particle counters are commonly used to determine the airborne particle contamination levels in cleanrooms and clean zones, and liquid particle counters are used to optically measure particle contamination levels in process fluids. Where microbiological particles are a particular concern, such as in the pharmaceutical industry, not only is quantification of the number of airborne particles important, but characterizing the viability and identity of microbiological particles is also at issue. ISO 14698-1 and 14698-2 provide standards for evaluation of cleanroom and clean zone environments for biocontaminants.

In at least some sterile, aseptic, or cleanroom environments, humans are routinely present in the environment to perform certain operations. In manufacturing barrier systems, for example, humans may be required to operate machines, manipulate objects, and otherwise interact with what is positioned inside the barrier system. Humans being present in such environments necessarily increases the risk of particulate and biological contamination levels. Increasingly, controlled environment systems are moving towards automated or robotic systems in order to limit or eliminate human interaction. Many applications requiring controlled environments also require or utilize human operated environmental sampling to ensure that viable and non-viable particles and/or organisms remain below the desired levels. As requirements for lower viable and non-viable particle concentrations increase because of increased quality standards and governmental regulatory requirements there is a need for advancement in sampling technology in order to reduce false positives and reduce the risk of outside contamination from human interactions within the controlled environment.

It can be seen from the foregoing that there remains a need in the art for particle collection, analysis, and characterization systems for sampling and collecting particles and/or organisms from controlled environments with reduced human interaction in order to reduce the risk of further contamination. These systems may include collection any analysis of particles within components of a robotic restricted access barrier system or other automated controlled environmental processes.

### SUMMARY OF THE INVENTION

Provided herein are systems and methods for sampling of controlled environments, including automated and/or robotically controlled sampling. The present systems and methods are useful for determining the presence of, quantity, size, concentration, viability, species or characteristics of particles, including viable biological particles, within a controlled environment. The described systems and methods may utilize rotational motion via robotics, automation and/or control systems to reduce, or eliminate, some or all of the steps carried out by human operators in traditional particle collection and/or analysis methodologies. The described systems and methods may include rotational motion via robotics, automation and/or control systems to provide for particle sampling over time periods that are well-defined for an individual impactor and/or sequential sampling via a plurality of impactors.

The provided systems and methods are compatible with a range of controlled environments, including aseptic environments, for example, restricted access barrier system (RABS) and isolator systems. These systems and methods allow for integration with an impactor in the controlled environment to position, connect, transport, actuate, sample and/or analyze the environmental conditions within the controlled environment with limited, or no human contact. The described systems and methods, therefore, reduce the risk of contamination from particles or organisms present on operators. The described systems and methods may provide for sampling and identification of viable biological particles with reduced false positives.

In an aspect, provided is a robotic sampling system for sampling particles, such as biological particles, within an enclosure, the system comprising: (i) an impactor for holding a growth medium, the impactor comprising: (a) a sampling head comprising one or more intake apertures for sampling a stream of and/or other gases inside the enclosure; (b) an impactor base containing a growth medium for receiving particles, such as biological particles, from the stream of air and/or other gases, the growth medium having an impact surface for receiving particles from the stream of air and/or other gases; (c) a selectively removable cover for covering the one or more intake apertures; and (d) an outlet for exhausting the stream of air and/or other gases; and (ii) a robotic manipulator system configured to rotate the impactor from a dormant pose into a sampling pose, optionally wherein the robotic manipulator system includes one or more processors and/or device components, such as implemented by software and/or hardware, for controlling integration, rotation, actuation, cover removal, transport, establishing fluid flow, closing the cover and/or removal of the impactor(s).

In an embodiment, the system is provided in fluid communication with the enclosure. In an embodiment, the system is provided in the enclosure.

In some embodiments, the system comprises a plurality of impactors, wherein the system is capable of controlling the plurality of samplers to provide for sequential sampling, continuous sampling and/or sampling of each impactor for a well-defined timeframe. In some embodiments, the system from 1 to 1000 impactors. In some embodiments, impactors that have been subject to sampling are removed from the systems, for example for analysis for biological particles. In some embodiments, new impactors are provided to the system, for example, to provide sequential and/or continuous sampling. In some embodiments, the impactor is a single-use device and/or a disposable device.

In some embodiments, the selectively removable cover of the sampler includes a magnet configured to magnetically engage with the robotic manipulator system. In some embodiments, the robotic manipulator system is configured to remove the selectively removable cover via the magnet and/or configured to replace the selectively removable cover via the magnet. In some embodiments, the system further comprises a robotic arm, wherein the robotic arm includes a magnetic engagement mechanism to engage with the magnet of the selectively removable cover. In some embodiments, the magnetic engagement mechanism includes one or more electromagnets, such as 1 to 10 electromagnets, optionally 1 to 5 electromagnets.

In some embodiments, the selectively removable cover of the sampler includes a lever configured to facilitate the removal of the selectively removable cover via a robotic arm. In some embodiments, the lever includes a groove configured to engage with a gripping element of the robotic arm.

In some embodiments, the system is configured to rotate the samplers into the sampling pose in a sequential manner and/or to provide continuous sampling conditions. In some embodiments, the system is configured to robotically remove used impactors (e.g., samplers that have sampled fluid from the enclosure for a selected and/or well-defined time period) from the robotic manipulator system and robotically replace them with one or more new impactors, such as in a sequential manner or in a manner providing sampling for each sampler over a well-defined time period. In some embodiments, the robotic manipulator system is configured to: (i) rotate a first impactor of the plurality of impactors from a sampling pose to a dormant pose; and (ii) rotate a second impactor of the plurality of impactors from a dormant pose position to a sampling pose, optionally wherein the system is configured to perform steps (i) and (ii) simultaneously.

In some embodiments, the robotic manipulator system is configured to rotate the impactors in a sequential, simultaneous and/or continuous manner. In some embodiments, the sampling position of the first impactor has the same location and orientation as the sampling position of the second impactor. The impactor is locked and centered on the rotor through three reference points. The first point is the suction hole where the “hose nozzle” is inserted into the special suction hole of the rotor. A second point is composed of a shaped support so that the impactor rests on the lower part in at least two points that prevent rotation. A third point consists of a locking made with two pins that block its vertical movement after being inserted into the housing.

In some embodiments, the system rotates the impactors along a well-defined and/or reproducible trajectory, for example, such that at least a portion of the impactors are provide in substantially the same location and/or orientation during sampling. In some embodiments, the system is configured to rotate the impactor along a trajectory following a portion of or a complete circle. In some embodiments, the robotic manipulator system rotates the impactor from a dormant pose into a sampling pose, wherein the impactor has a trajectory characterized by an arc having an arc length selected from 10 to 180°. In some embodiments, the robotic manipulator system rotates the impactor from a dormant pose into a sampling pose, wherein the impactor has a trajectory characterized by an arc having an arc length equal to 360° divided by the maximum number of impactors the system is configured to hold. In one embodiment, the robotic manipulator system is configured to hold three impactors and the robotic manipulator system rotates the impactor from a dormant pose into a sampling pose, wherein the impactor has a trajectory characterized by an arc having an arc length of 120°.

In some embodiments, the rotation occurs about a horizontal axis. In some embodiments, the rotation occurs about a vertical axis. In some embodiments, the impact surface is oriented horizontally when the impactor is in the sampling position. In some embodiments, the impact surface is oriented vertically when the impactor is in the dormant position. In some embodiments, the system further comprises a flow system for flowing the fluid through the particle detection device. The flow system may comprise a pump, vacuum, blower, fluid actuator and/or house vacuum line.

In some embodiments, the flow system is configured to initiate flow through the impactor in response to: the robotic manipulator system manipulating the impactor into a sampling pose and/or removing the selectively removable cover. In some embodiments, the flow system is configured to cease flow through the impactor in response to the expiration of a predetermined sampling duration. In some embodiments, the robotic manipulator system is configured to replace the selectively removable cover in response to: the ceasing of flow through the impactor and/or the expiration of the predetermined duration. In some embodiments, the predetermined duration is selected from the range of 1 to 1,000 hours. In some embodiments, the robotic manipulator system is configured to manipulate the used impactor into a dormant pose in response to the selectively removable cover being replaced. In some embodiments, in response to the used impactor being manipulated into a dormant pose, the robotic manipulator system is configured to manipulate a new impactor into a sampling pose and/or remove the selectively removable cover of the new impactor. The flow system may then initiate flow though the new impactor. Thus, in some embodiments, the system may provide essentially continuous, autonomous sampling via the sequential use of a plurality of impactors. In some embodiments, the essentially continuous, autonomous sampling via the sequential use of the plurality of impactors has a predetermined duration of 1 to 10,000 hours

In some embodiments, the system further comprises a rotor mechanism, wherein the rotor mechanism is configured to engage a plurality of impactors disposed thereon, the impactors being oriented around a rotational axis of the rotor mechanism, wherein the rotor mechanism is configured to rotate about the rotational axis. In one embodiment, the rotational axis is substantially horizontal. For example in one embodiment, the rotational axis is within 10 degrees of horizontal. In one embodiment, the rotational axis is within 5 degrees of horizontal.

In one embodiment, each impactor has a bottom surface, opposite the impact surface; and each impactor is disposed on the rotor mechanism such that the bottom surface of each impactor is oriented toward the rotational axis. In one embodiment, the system is configured such that when an impactor is rotated into the sampling pose, the impact surface of the impactor is substantially horizontal and facing upwards, and the impactor is located at a highest point on a rotational path traced by the rotor mechanism. In one embodiment, when an impactor is rotated into a dormant position, the impact surface of the impactor is not substantially horizontal and/or not facing upwards.

In one embodiment, the rotational axis is substantially vertical. For example, in one embodiment, the rotational axis is within 10 degrees of vertical. In one embodiment, the rotational axis is within 5 degrees of vertical.

In one embodiment, the impact surface of each impactor remains substantially horizontal as it is rotated from dormant position to a sampling position by the rotor mechanism. In one embodiment, the plurality of impactors are disposed on the rotor mechanism such that each impactor traces the same rotational path, the rotational path defining a substantially horizontal plane.

In one embodiment, each impactor is spaced equidistant from the rotational axis.

In some embodiments, the system further comprises a status indicator to indicate whether the system is in sampling mode, standby mode, and/or completed sampling mode.

In some embodiments, the robotic manipulator system is configured to expose the inlet of the particle detection device to a fluid sample, such as one or more gases, from the enclosure, such as air, processes gases, sterilant and any combination of these. In some embodiments, the robotic manipulator system is configured to collect particles from the particle detection device. In some embodiments, the robotic manipulator system is configured to operate the particle detection device in the absence of physical contact of the particle detection device by a user.

In some embodiments, the robotic manipulator system is configured to connect the particle detection device to the flow system. In some embodiments, the robotic manipulator system is configured to open the inlet to allow for fluid flow into and through the particle detection device. In some embodiments, the particle detection device comprises a cover for enclosing the inlet, and the robotic manipulator system is configured to remove the cover to allow for fluid to enter the inlet. In some embodiments, the robotic manipulator system is configured to replace the cover to stop the fluid from entering the inlet. In some embodiments, the robotic manipulator system is configured to close the inlet to stop fluid flow into the particle detection device.

In some embodiments, the flow system is located within a cleanroom or aseptic environment, and the robotic manipulator system is configured to sample the particles from fluid, such as gases, from the enclosure, in the absence of a user being physically present in the cleanroom or aseptic environment. In some embodiments, the robotic manipulator system is located inside of the cleanroom or aseptic environment.

In some embodiments, the enclosure is an aseptic enclosure, a restricted access barrier system (RABS) or a positive pressure isolator system. In some embodiments, the system is for detection of biological particles, such as microorganisms, in a fluid sample, such as gases in, or form, the enclosure, such as air, sterilized air, process gases, sterilant or any combination thereof.

The present systems and methods are compatible with a range of impactors and sampling conditions, including non-laminar sample flow conditions and substantially laminar sample flow conditions.

In an aspect, provided is a method of sampling particles, such as biological particles, within, or from, an enclosure, the method comprising: (i) rotating an impactor from a dormant pose into a sampling pose via a robotic manipulator system; (ii) removing a selectively removable cover covering one or more intake apertures of the impactor; and (iii) sampling a stream of air and/or other gases from within or from the enclosure via the impactor, the sampling comprising: (a) intaking the stream of air and/or other gases via a sampling head comprising the one or more intake apertures; (b) impacting particles, such as biological particles, from the stream of air and/or other gases onto an impact surface of a growth medium in an impactor base of the impactor; and (c) exhausting the stream of air and/or other gases from the impactor via an outlet of the impactor; optionally wherein the rotating, removing, and sampling steps is carried out and/or controlled by one or more processors and/or device components, such as implemented by software and/or hardware, for example, for controlling integration, rotation, actuation, cover removal, transport, establishing fluid flow, closing the cover and/or removal of the impactor(s).

In an aspect, provided is a method of controlling a robotic sampling system for sampling of particles within an enclosure, the method comprising: (i) providing first instructions to a robotic manipulator system, the first instructions configured to cause the robotic manipulator system to rotate an impactor from a dormant pose into a sampling pose; (ii) providing second instructions to the robotic manipulator system, the second instructions configured to cause the robotic manipulator system to remove a selectively removable cover form the impactor; and (iii) providing third instructions to a fluid actuation system, the third instructions configured to cause the fluid actuation system to intake air and/or other gases from the enclosure into the impactor, optionally wherein the first, instructions, second instructions and/or third instructions originate from one or more processors and/or device components, such as implemented by software and/or hardware, for example, for controlling integration, rotation, actuation, cover removal, transport, establishing fluid flow, closing the cover and/or removal of the impactor(s).

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A and 1B provide a top view and side view, respectively of a first embodiment of a robotic sampling system.

FIGS. 2A-2I provide a sequence of schematics demonstrating operation of the first embodiment of the robotic sampling system.

FIGS. 3A and 3B provide schematics diagrams of one embodiment of an impactor useful in the present systems and methods.

FIG. 3C shows a perspective view of a selectively removable cover of an impactor of the invention.

FIG. 3D shows a bottom view of the selectively removable cover of FIG. 3C.

FIG. 3E shows a cross sectional view of the selectively removable cover of FIGS. 3C-D.

FIG. 4 shows a side elevation view of a second embodiment of a robotic sampling system.

FIG. 5 shows a front elevation view of the second embodiment of the robotic sampling system.

FIG. 6 shows a rear elevation view of the second embodiment of the robotic sampling system.

FIG. 7 shows a side elevation view of process of loading impactors into the second embodiment of the robotic sampling system.

FIG. 8 shows an isometric view of the second embodiment of the robotic sampling system.

FIG. 9 shows a front elevation view of a third embodiment of a robotic sampling system.

FIG. 10 shows a side elevation view of the third embodiment of the robotic sampling system.

FIG. 11 shows an isometric view of the third embodiment of the robotic sampling system.

FIGS. 12-15 illustrate one embodiment of the process of robotically removing the selectively removable cover of an impactor and positioning the impactor to collect samples.

FIG. 16 shows a perspective view of a fourth embodiment of a robotic sampling system.

FIG. 17 shows one example of a robotic arm for removing and replacing the selectively removable cover is shown. In the illustrated embodiment, the robotic arm includes a gripping element comprising a forked structure.

FIG. 18 shows two different embodiments of the sampling paths for viable and non-viable particles are shown. In the embodiment on the left, the impactors are configured to rotate in a vertical plane and the system is configured to mount to a horizontal surface. In the embodiment on the right, the impactors are configured to rotate in a horizontal plane.

FIG. 19 shows an illustration of a removing the selectively removable cover from an impactor via a robotic arm and rotating the impactor into a sampling pose.

FIG. 20 shows an illustration of a rotor mechanism having five impactors disposed thereon.

FIG. 21 shows an illustration of an apparatus for removing and replacing the selectively removable cover of an impactor via one hand by a user. The apparatus may have a magnet configured to magnetically engage with a magnet of a selectively removable cover of an impactor.

FIG. 22 shows an illustration of a robotic sampling system in accordance with one embodiment of the present disclosure. The system may include some or all of the features of the embodiment of FIGS. 11-15, and furthermore the system may be mounted to a mobile robotic platform.

FIG. 23 shows an illustration of a method and system for robotic sampling via a robotic sampling system including a mobile robotic platform. The illustrated system and method includes autonomously receiving unused impactors from an impactor dispensing station, navigating to a sampling location for sampling via the impactors, navigating to an incubator station, and incubating the impactors via the incubator station, all without direct human intervention.

FIG. 24 shows an illustration of one embodiment of navigating to sampling location, docking with an enclosure, and collecting one or more samples from inside the enclosure.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

“Particle” refers to a small object which is often regarded as a contaminant. A particle can be any material created by the act of friction, for example when two surfaces come into mechanical contact and there is mechanical movement. Particles can be composed of aggregates of material, such as dust, dirt, smoke, ash, water, soot, metal, minerals, or any combination of these or other materials or contaminants. “Particles” may also refer to biological particles, for example, viruses, spores and microorganisms including bacteria, fungi, archaea, protists, other single cell microorganisms. Biological particles include, but are not limited to, microorganisms having a size on the order of 0.1-20 μm. Biological particles include viable biological particles capable of reproduction, for example, upon incubation within a growth media. A particle may refer to any small object which absorbs or scatters light and is thus detectable by an optical particle counter. As used herein, “particle” is intended to be exclusive of the individual atoms or molecules of a carrier fluid, for example, such gases present in air (e.g., oxygen molecules, nitrogen molecules, argon molecule, etc.) or process gases. Some embodiments of the present invention are capable of sampling, collecting, detecting, sizing, and/or counting particles comprising aggregates of material having a size greater than 50 nm, 100 nm, 1 μm or greater, or 10 μm or greater. Specific particles include particles having a size selected from 50 nm to 50 μm, a size selected from 100 nm to 10 μm, or a size selected from 500 nm to 5 μm.

The expression “sampling a particle” broadly refers to collection of particles in a fluid flow, for example, from an environment undergoing monitoring. Sampling in this context includes transfer of particles in a fluid flow to an impact surface, for example, the receiving surface of a growth medium. Alternatively, sampling may refer to passing particles in a fluid through a particle analysis region, for example, for optical detection and/or characterization. Sampling may refer to collection of particles having one or more preselected characteristics, such as size (e.g., cross sectional dimension such as diameter, effective diameter, etc.), particle type (biological or nonbiological, viable or nonviable, etc.) or particle composition. Sampling may optionally include analysis of collected particles, for example, via subsequent optical analysis, imaging analysis or visual analysis. Sampling may optionally include growth of viable biological particles, for sample, via an incubation process involving a growth medium. A sampler refers to a device for sampling particles.

“Impactor” refers to a device for sampling particles. In some embodiments, an impactor comprises a sample head including one or more intake apertures for sampling a fluid flow containing particles, whereby at least a portion of the particles are directed onto an impact surface for collection, such as the receiving surface of a growth medium (e.g., culture medium such as agar, broth, etc.) or a substrate such as a filter. Impactors of some embodiments, provide a change of direction of the flow after passage through the intake apertures, wherein particles having preselected characteristics (e.g., size greater than a threshold value) do not make the change in direction and, thus, are received by the impact surface.

The expression “detecting a particle” broadly refers to sensing, identifying the presence of, counting and/or characterizing a particle, such as characterizing a particle with respect to a size dimension, such as effective diameter. In some embodiments, detecting a particle refers to counting particles. In some embodiments, detecting a particle refers to characterizing and/or measuring a physical characteristic of a particle, such as effective diameter, cross sectional dimension, shape, size, aerodynamic size, or any combination of these. In some embodiments, detecting a particle is carried out in a flowing fluid, such as gas having a volumetric flow rate selected over the range of 0.05 CFM to 10 CFM, optionally for some applications 0.1 CFM to 5 CFM and optionally for some applications 0.5 CFM to 2 CFM. In some embodiments, detecting a particle is carried out in a flowing fluid, such as liquid having a volumetric flow rate selected over the range of 1 to 1000 mL/min.

“Flow direction” refers to an axis parallel to the direction the bulk of a fluid is moving when a fluid is flowing. For fluid flowing through a straight flow cell, the flow direction is parallel to the path the bulk of the fluid takes. For fluid flowing through a curved flow cell, the flow direction may be considered tangential to the path the bulk of the fluid takes.

“Fluid communication” refers to the arrangement of two or more objects such that a fluid can be transported to, past, through or from one object to another. For example, in some embodiments two objects are in fluid communication with one another if a fluid flow path is provided directly between the two objects. In some embodiments, two objects are in fluid communication with one another if a fluid flow path is provided indirectly between the two objects, such as by including one or more other objects or flow paths between the two objects. For example, in one embodiment, the following components of a particle impactor are in fluid communication with one another: one or more intake apertures, an impact surface, a fluid outlet, a flow restriction, a pressure sensor, a flow generating device. In one embodiment, two objects present in a body of fluid are not necessarily in fluid communication with one another unless fluid from the first object is drawn to, past and/or through the second object, such as along a flow path.

“Flow rate” refers to an amount of fluid flowing past a specified point or through a specified area, such as through intake apertures or a fluid outlet of a particle impactor. In one embodiment a flow rate refers to a mass flow rate, i.e., a mass of the fluid flowing past a specified point or through a specified area. In one embodiment, a flow rate is a volumetric flow rate, i.e., a volume of the fluid flowing past a specified point or through a specified area.

“Operably connected,” “operatively coupled,” “operatively connected,” and “operatively coupled” refers to a configuration of elements, wherein an action or reaction of one element affects another element, but in a manner that preserves each element's functionality. The connection may be by a direct physical contact between elements. The connection may be indirect, with another element that indirectly connects the operably connected elements. The term also refers to two or more functionally-related components being coupled to one another for purposes of flow of electric current and/or flow of data signals. This coupling of the two or more components may be a wired connection and/or a wireless connection. The two or more components that are so coupled via the wired and/or wireless connection may be proximate one another (e.g., in the same room or in the same housing) or they may be separated by some distance in physical space (e.g., in a different building).

The term “pose” refers to a combination of: (i) location of an object in three dimensional space (e.g., x, y, z coordinates relative to a reference point); and (ii) orientation of the object relative to the direction of the force of gravity of the earth (e.g., the object may have a reference surface oriented vertically such that the surface is parallel to the direction of the force of gravity of the earth).

The term “sampling pose” refers to an orientation and location of an impactor, the orientation and location of the impactor being predetermined and configured to facilitate repeatable, location-specific viable particle collection via the impactor. In one embodiment, the sampling pose may be such that an impact surface of the impactor is substantially horizontal. In one embodiment, a plurality of impactors may be disposed on a rotor mechanism, the rotor mechanism being configured to rotate the rotors, and hence the impactors, about a substantially horizontal rotational axis, wherein the sampling pose corresponds to: (i) the impactor being located at the highest point on a vertically-oriented circle traced by the impactor as it rotates about the horizontal rotational axis; and (ii) the impact surface of the impactor being substantially horizontal. In one embodiment, a plurality of impactors may be disposed on a rotor mechanism, the rotor mechanism being configured to rotate the rotors, and hence the impactors, about a substantially vertical rotational axis, wherein the sampling pose corresponds to: (i) the impactor being located at a predetermined point on a horizontally-oriented circle traced by the impactor as it rotates about the vertical rotational axis; and (ii) the impact surface of the impactor being substantially horizontal.

The term “substantially horizontal” refers to an orientation that is horizontal to within a predetermined angle. In one embodiment, substantially horizontal refers to an orientation that is less than 45 degrees from horizontal. In one embodiment, substantially horizontal refers to an orientation that is less than 35 degrees from horizontal. In one embodiment, substantially horizontal refers to an orientation that is less than 25 degrees from horizontal. In one embodiment, substantially horizontal refers to an orientation that is less than 15 degrees from horizontal. In one embodiment, substantially horizontal refers to an orientation that is less than 10 degrees from horizontal. In one embodiment, substantially horizontal refers to an orientation that is less than 5 degrees from horizontal. In one embodiment, substantially horizontal refers to an orientation that is less than 2 degrees from horizontal. In one embodiment, substantially horizontal refers to an orientation that is less than 1 degree from horizontal.

The term “substantially vertical” refers to an orientation that is vertical to within a predetermined angle. In one embodiment, substantially vertical refers to an orientation that is less than 45 degrees from vertical. In one embodiment, substantially vertical refers to an orientation that is less than 35 degrees from vertical. In one embodiment, substantially vertical refers to an orientation that is less than 25 degrees from vertical. In one embodiment, substantially vertical refers to an orientation that is less than 15 degrees from vertical. In one embodiment, substantially vertical refers to an orientation that is less than 10 degrees from vertical. In one embodiment, substantially vertical refers to an orientation that is less than 5 degrees from vertical. In one embodiment, substantially vertical refers to an orientation that is less than 2 degrees from vertical. In one embodiment, substantially vertical refers to an orientation that is less than 1 degree from vertical.

The term “dormant pose” refers to an orientation and location of a impactor for which at least one of the following is true: (i) the impact surface of the impactor is not substantially horizontal; and/or (ii) the location of the impactor does not correspond to a predetermined sampling location.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

Human presence, operation and intervention in clean rooms is considered to be the greatest source of contamination risk.

In an embodiment, the present systems and methods address this risk by using a impactor to be at the sampling point that is preloaded, to a system command or sampling tool configured to perform the following steps:
I. Remove the cover of the impactor; wherein the system command or sampling tool retains the cap of the impactor, thereby allowing for sampling;
II. Place the impactor with agar or other media at the sampling point;
III. Initiate active or passive sampling;
IV. At a predetermined time and/or at a command of the system or sampling instrument the cover is reapplied to the impactor, a new impactor enters the cycle described by the previous points.

Thus, in some embodiments, the system may provide essentially continuous (i.e., continuous with the exception of the time necessary to switch between impactors), autonomous sampling via the sequential use of a plurality of impactors.

The systems and methods of the invention provide certain benefits including:
I. The device minimizes the risk of contamination of clean rooms by replacing the major source of contamination (human contact);
II. The automation of the process cancels human error and makes the process itself more uniform and repeatable; and
III. Greater temporal coverage of the production process is guaranteed with microbiological monitoring, which may be continuous or sequential.

### Example 1—Robotic Sampling System with Substantially Horizontal Rotational Axis and Configured to Mount to Vertical Surface

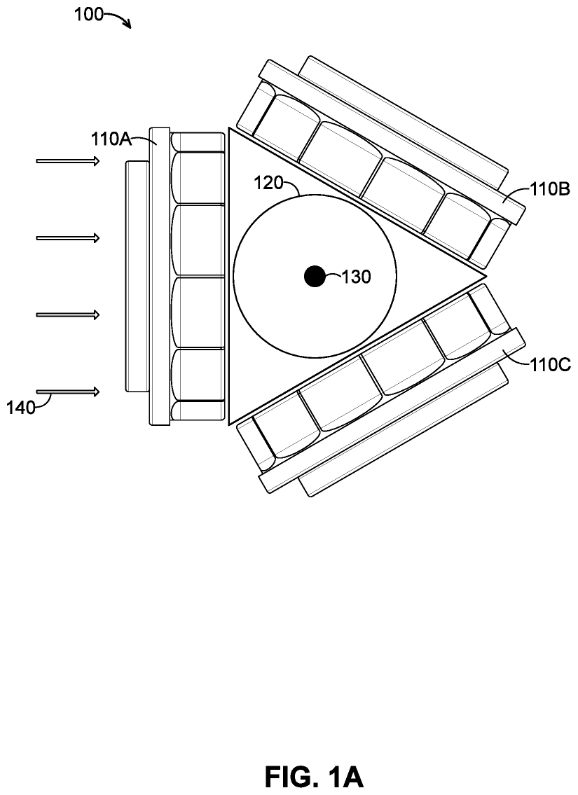

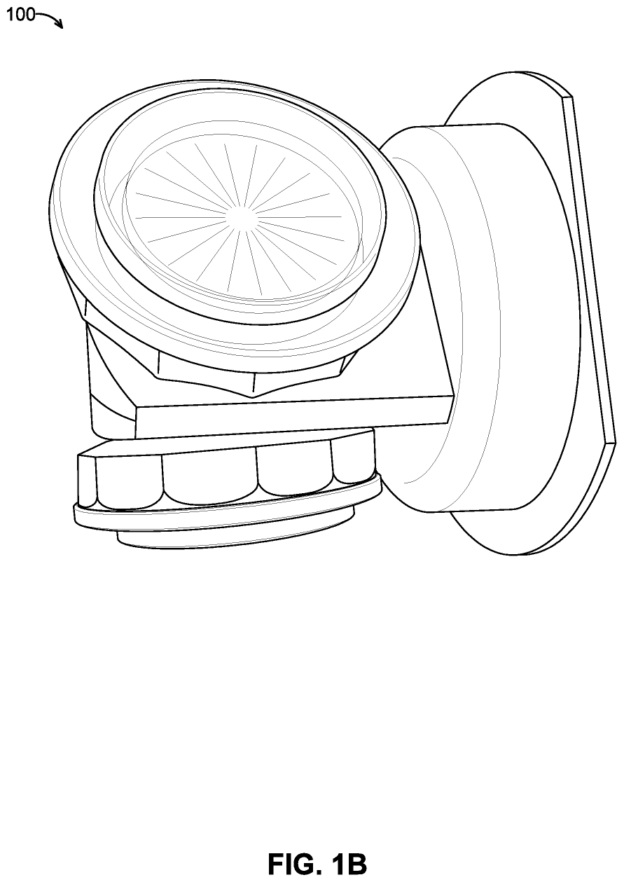

FIGS. 1A and 1B provide a top view and side view, respectively of a robotic sampling system. A shown, robotic sampling system 100 comprises impactors 110A, 110B and 110C, optionally single use and/or disposable impactors, operationally connected to rotor 120, which is configured to rotate around central rotational axis 130. Rotation of rotor 120 rotates impactors 110A, 110B and 110C, for example, from a dormant pose into a sampling pose. In the embodiment shown FIGS. 1A and 1B, impactor 110A is in a sampling pose wherein it is in fluid communication with an environment under monitoring, wherein a flow of sample, air, other gases, particles, etc. (shown schematically as arrows 140) is provided to impactor 110A, and impactors 110B and 110C are in a dormant pose, such as in a closed condition. Given the orientation of central rotational axis 130, robotic sampling system 100 is characterized as having a substantially horizontal rotational axis. In an embodiment, robotic sampling system 100 is provided in an enclosure, or in fluid communication with an enclosure.

Rotation of rotor 120 around central rotational axis 130 moves impactors 110A, 110B and 110C along an arc trajectory, for example, along at least a portion of the circumference of a circle. In some embodiments, rotation allows impactors 110A, 110B and 110C to be capable of a sampling pose that is substantially in the same sampling location (shown in FIG. 1A as the location of moves impactor 110A), but allows for sampling at different times. In this manner robotic sampling system 100 is capable of sequential and/or continuous sampling.

In some embodiments, the sampling pose includes being open with a cover removed or closed but being capable of removal of the cover. The sampling pose is provided to allow for sampling of a stream of air and/or other gases, for example, under specific sampling conditions such as a selected time and/or for a selected duration. In some embodiments, the dormant pose is a closed configuration, for example when the cover is in place. In some embodiments, the dormant pose corresponds to conditions prior to sampling or after sampling, such as when the impactor is in a sealed configuration.

In the embodiment shown in FIGS. 1A and 1B, impactors 110A, 110B and 110C are single use and/or disposable impactors. In some embodiments, impactors 110A, 110B and 110C each independently comprise: (i) a sampling head comprising one or more intake apertures for sampling a stream of air and/or other gases inside the enclosure; (ii) an impactor base containing a growth medium for receiving particles from the stream of air and/or other gases, the growth medium having an impact surface for receiving particles from the stream of air and/or other gases; (iii) a selectively removable cover for covering the one or more intake apertures; and (iv) an outlet for exhausting the stream of air and/or other gases.

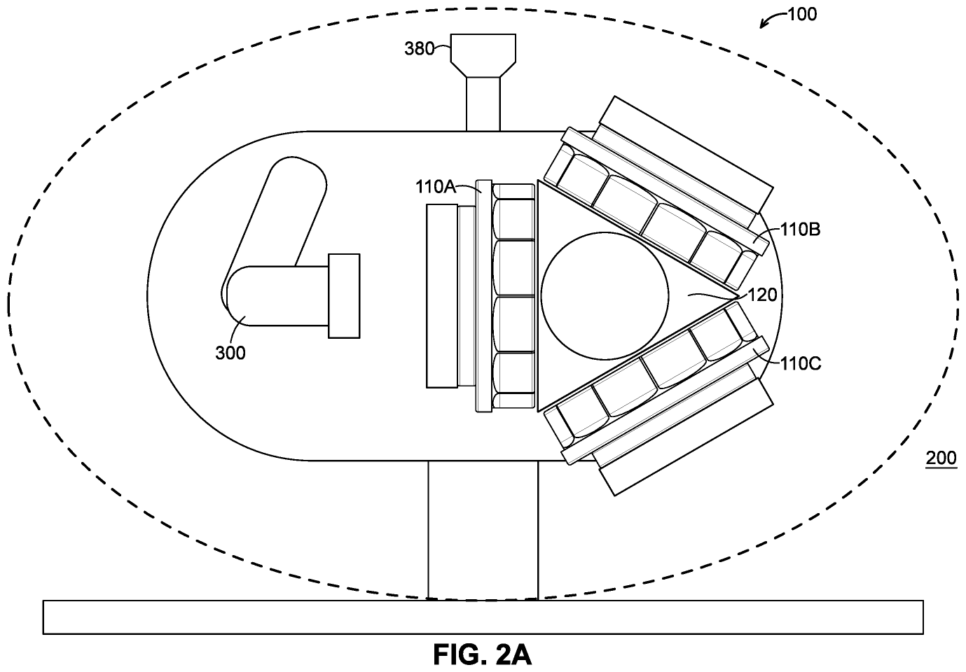

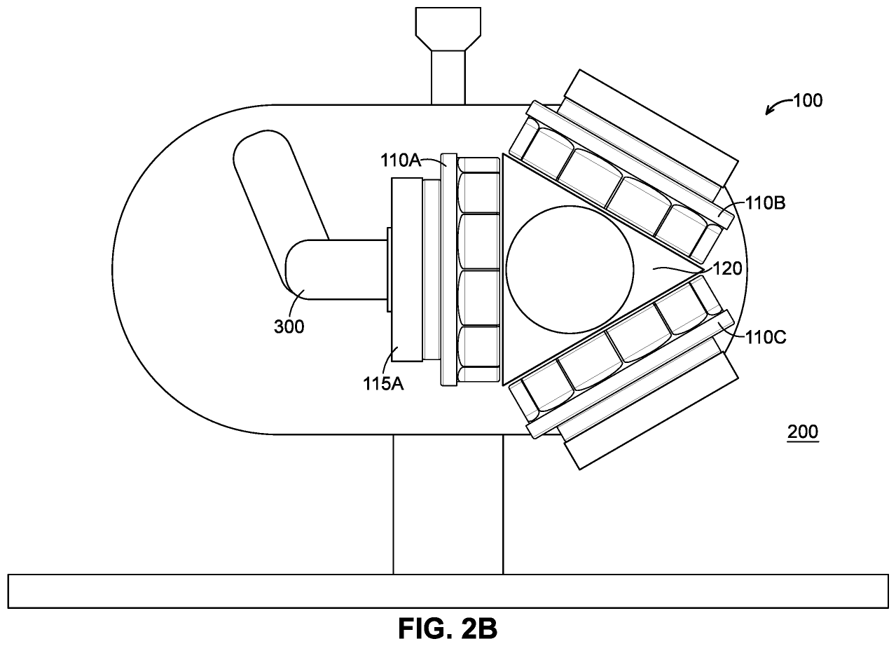

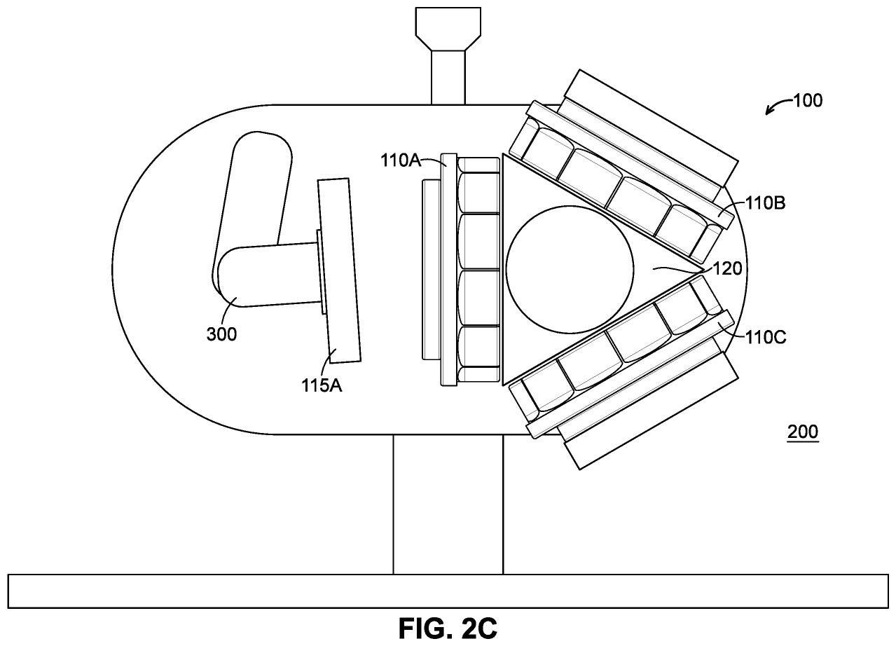

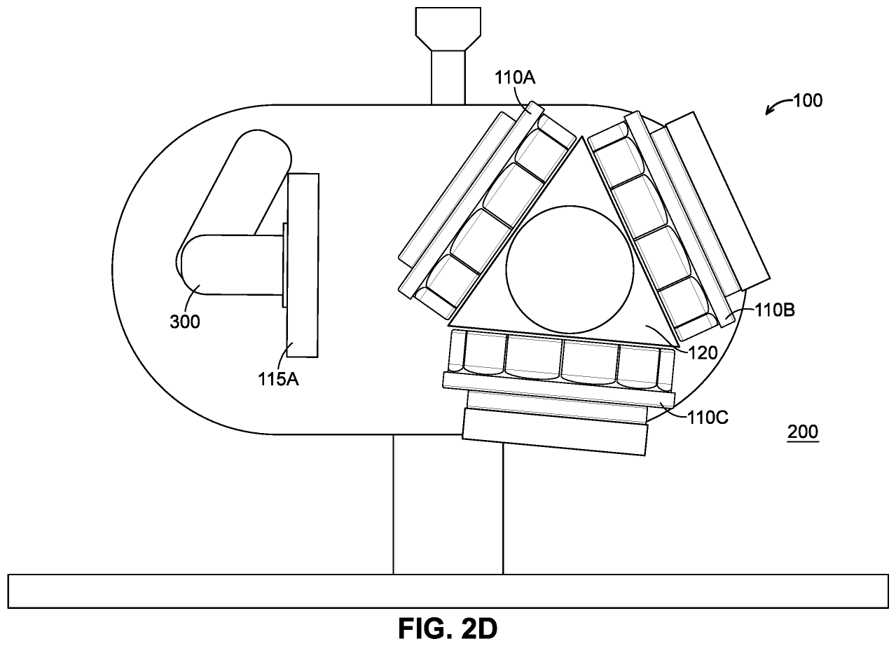

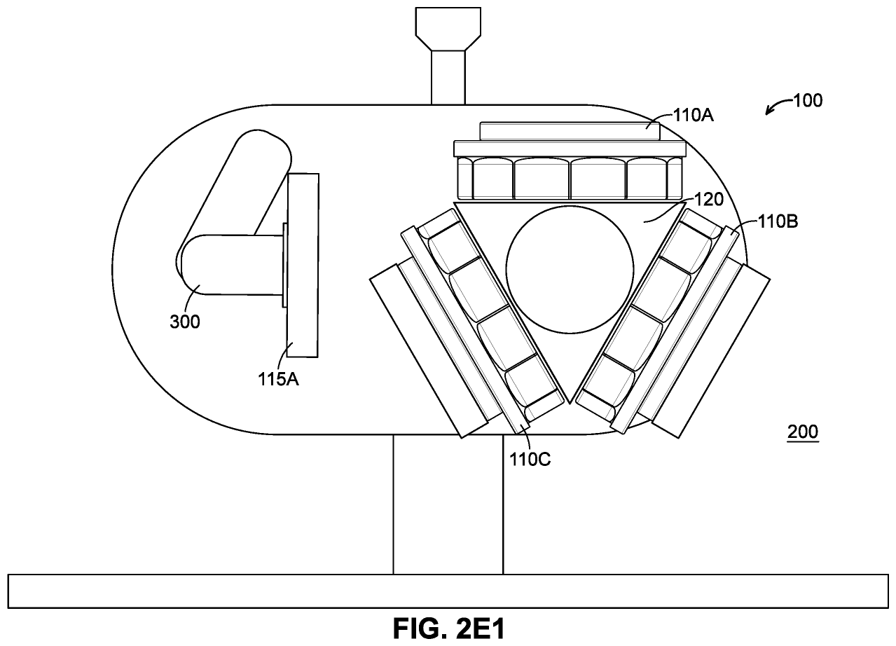

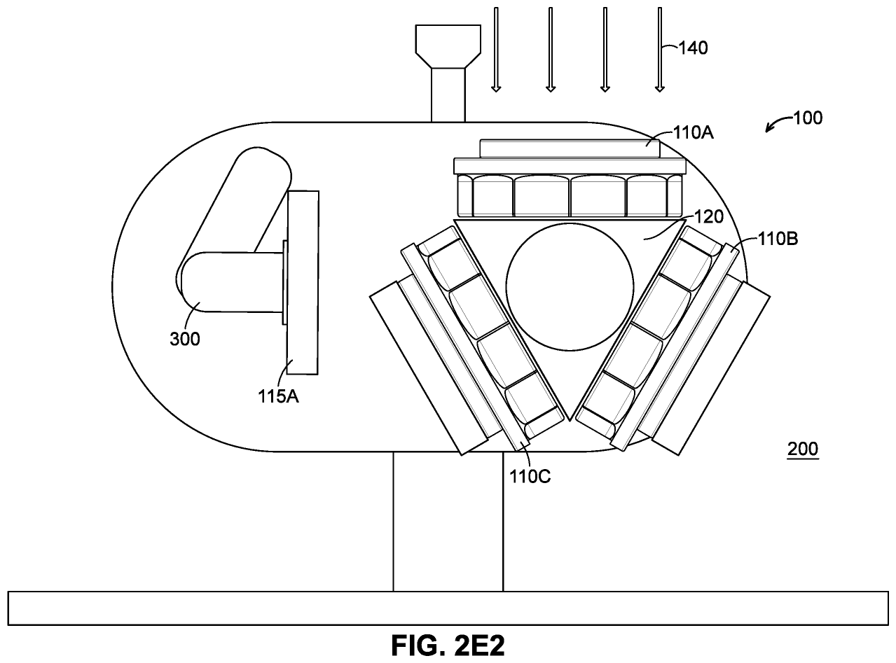

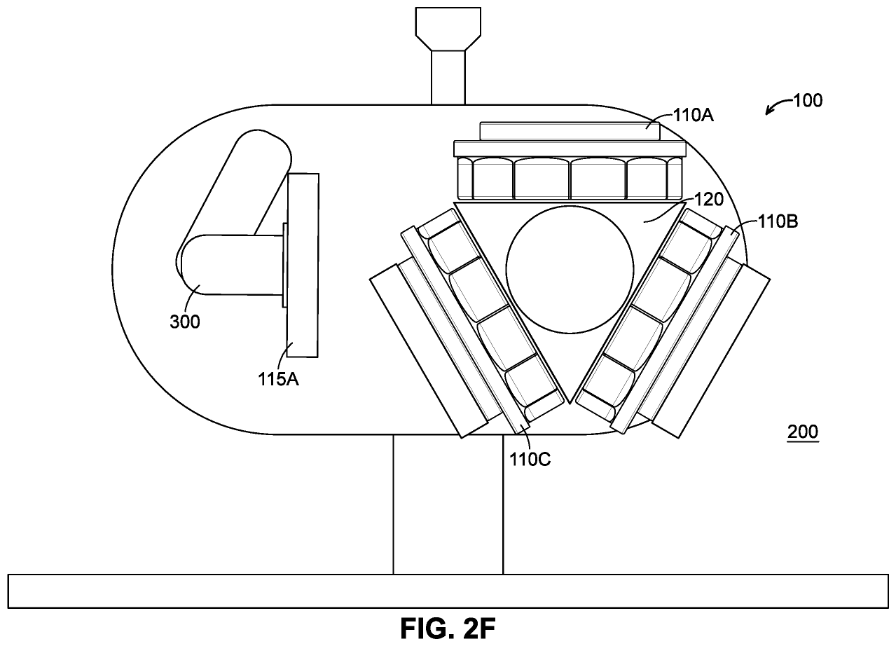

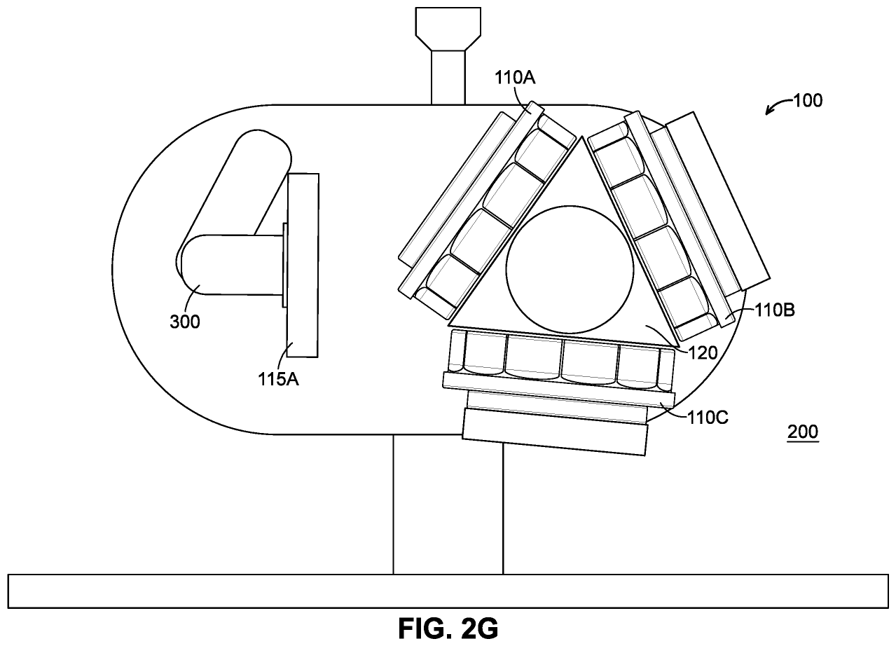

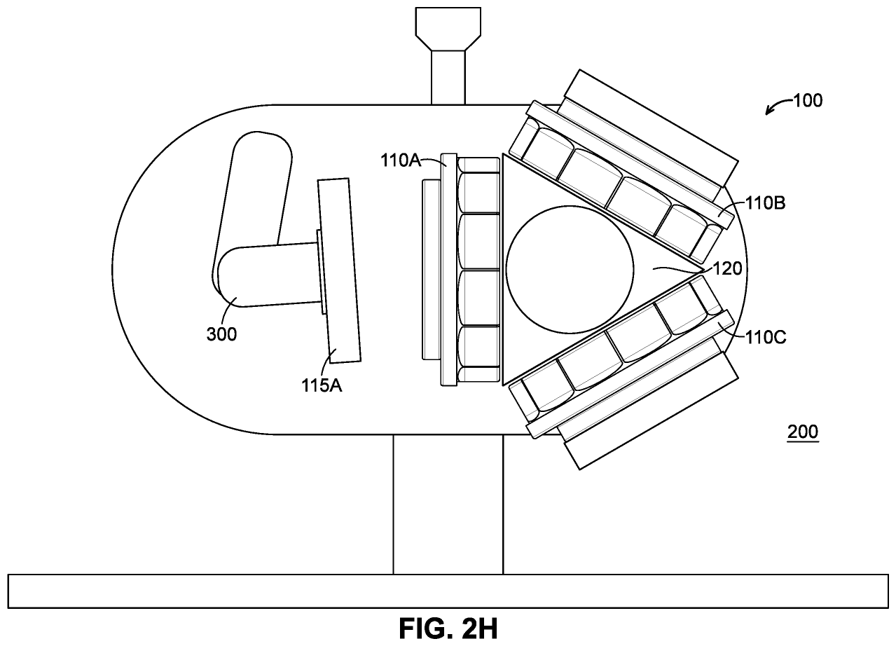

FIGS. 2A-2I, provide a sequence of schematics demonstrating operation of first embodiment of a robotic sampling system 100. The illustrated robotic sampling system 100 is provided in an enclosure 200, such as an aseptic enclosure, a restricted access barrier system (RABS) or a positive pressure isolator system.

FIG. 2A shows robotic sampling system 100 prior to sampling, wherein each of impactors 110A, 110B and 110C has a removable cover engaged, so as to prevent sampling and exposure of the growth medium to particles in gas form the enclosure, such as air, process gases and/or sterilant in the enclosure 200. As shown in FIG. 2A, robotic arm 300 is provided in an orientation not in physical in contact with any of impactors 110A, 110B and 110C. System 100 further includes isokinetic sampling probe 380 for counting non-viable particles. Probe 380 may be in communication with an optical particle counter (not shown). Thus, in some embodiments, the system 100 functions to count both viable and non-viable particles.

FIG. 2B shows robotic sampling system 100 at the start of actuation, wherein robotic arm 300 engages removable cover 115A of impactor 110A, for example by establishing magnetic coupling between removable cover 115A and robotic arm 300.

FIG. 2C shows robotic sampling system 100 during removal of the cover, wherein robotic arm 300 removes cover 115A of impactor 110A, by lifting off the cover 115A from the sampler head of the impactor 110A.

FIG. 2D shows robotic sampling system 100 during rotation, wherein rotation of rotor 120 around central rotational axis 130 moves impactors 110A, 110B and 110C along an arc trajectory. As shown in FIG. 2D, the impactor 110A is being rotated in a direction away from rotational arm 300.

FIG. 2D shows robotic sampling system 100 after rotation, wherein rotation of rotor 120 around central rotational axis 130 moves impactor 110A into a sampling pose and wherein 110B and 110C are in a dormant pose.

FIGS. 2E1 and 2E2 shows robotic sampling system 100 upon fluid actuation, wherein gas such as air, process gases and/or sterilant, from enclosure (schematically shown as arrows 140) is provided to impactor 110A, for example, by generating a fluid flow through the impactor, wherein at least a portion of particles in the gas sample are sampled and come into contact with the grow medium housed by impactor 110A.

FIG. 2F shows robotic sampling system 100 after sampling, wherein gas such as air, process gases and/or sterilant, from enclosure is no longer provided to impactor 110A, for example, by stopping fluid actuation and/or providing a removable cover to impactor 110A.

FIG. 2G shows robotic sampling system 100 during rotation, wherein rotation of rotor 120 around central rotational axis 130 moves impactors 110A, 110B and 110C along an arc trajectory. As shown in FIG. 2G, the impactor 110A is being rotated in a direction toward rotational arm 300.

FIG. 2G shows robotic sampling system 100 after rotation, wherein impactor 110A is moved in position to receive removable cover 115A.

FIG. 2I shows robotic sampling system 100 upon return of the cover, wherein robotic arm 300 provides removable cover 115A to impactor 110A, for example, when the removable cover seals impactor such as via a magnetic engagement between the removable cover and the sampler head.

In some embodiments, the flow of sample (e.g., 140) to impactors 110A, 110B and/or 110C may be non-laminar. Under certain sampling conditions, for example, there may be a steep air velocity gradient on either side of the sampling head slits and/or apertures, along the axis of the flow direction. In some embodiments, the thickness of the sampling head slit along the flow axis is insufficient to provide a flow path allowing for a stable laminar flow to develop within the slit or aperture, even if the Reynolds number is within the laminar flow regime, as it may take a certain time/distance for stable, laminar flow to form. The present robotic control systems is compatible, however, with other impactors and conditions including quasi-laminar and substantially laminar flows, for example, a flow characterized by a Reynolds number within the laminar flow regime and/or minimal velocity gradient along the flow axis.

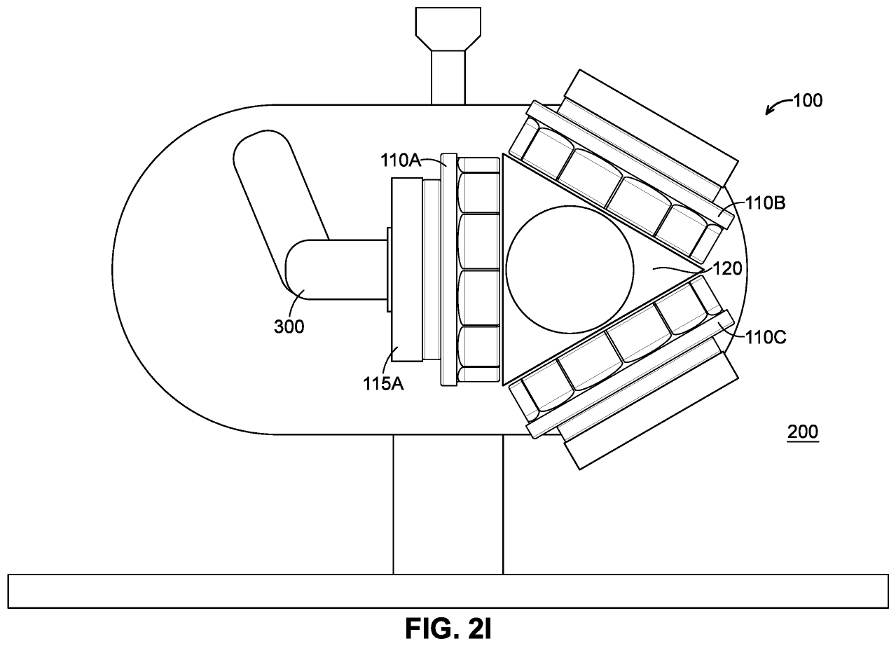

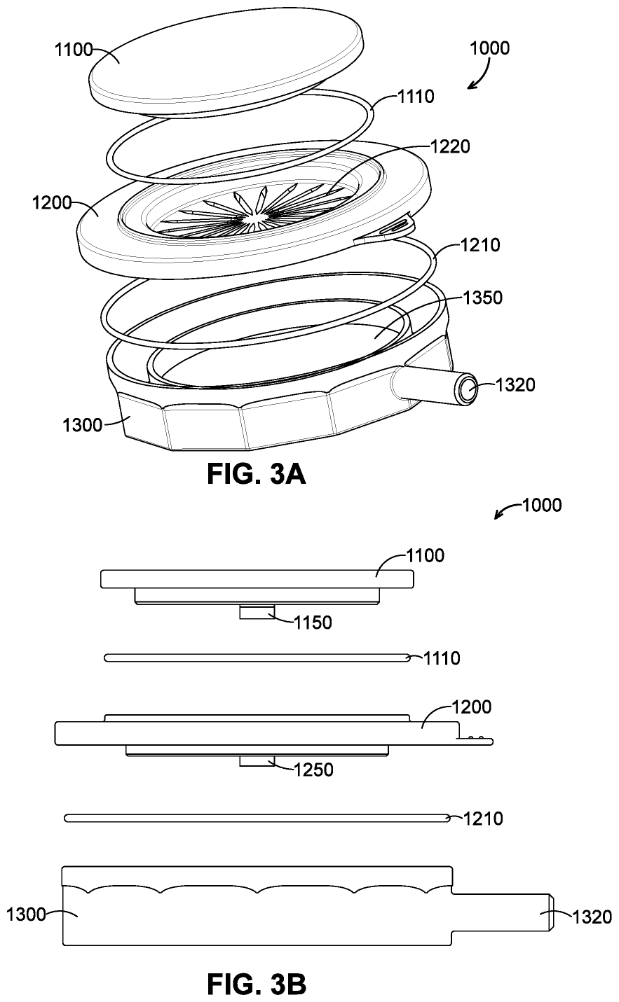

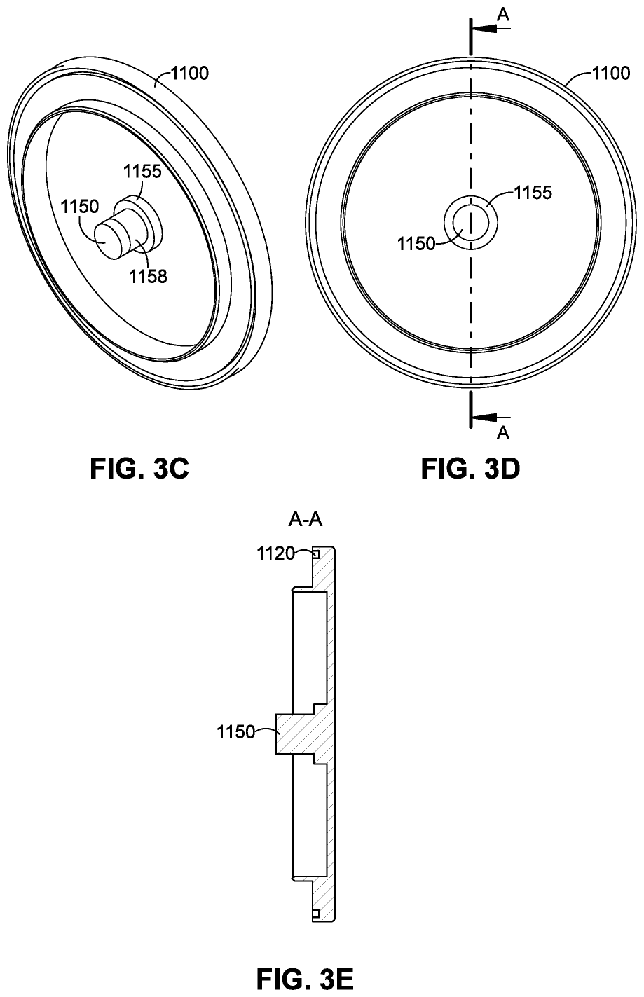

FIGS. 3A and 3B provide schematics diagrams of impactors useful in the present systems and methods. FIG. 3A is a perspective exploded view of a particle impactor 1000 and FIG. 2 is a side exploded view of the particle impactor 1000. As shown in these figures, particle impactor 1000 comprises a sampling head 1200, a selectively removable cover 1100 and an impactor base 1300. The sampling head 1200 includes a sampling head magnet 1250 fixed to the underside of the sampling head 1200. The selectively removable cover 1100 includes a first cover magnet 1155 and a second cover magnet 1150 fixed to the underside of the cover 1100, and spaced apart via a spacer. The sampling head magnet 1250 engages with the second cover magnet 1150 in order to secure the cover 1100 to the impactor. The sampling head 1200 and the selectively removable cover 1100 engage via compressible sealing member 1110. The impactor 1000 is configured to compress the compressible sealing member 1110 via magnetic attraction between the sampling head magnet 1250 and the second cover magnet 1150. The sampling head 1200 and the impactor base 1300 engage via compressible sealing member 1210. The first cover magnet 1155 may be configured to engage with a robotic device, such as a robotic manipulator system.

The sampling head 1200 includes a plurality of intake apertures 1220 for sampling a fluid flow containing particles. The impactor base 1300 includes an outlet 1320 and an impact surface 1350. In operation, gas flow is directed through the intake apertures 1220 of the sampling head 1100 where it is accelerated towards the impact surface 1350, and out the outlet 1320 which forces the gas to rapidly change direction. Due to their momentum, particles entrained in the gas flow are unable to make the rapid change in direction and impact on the impact surface 1350.

In embodiments, impact surface 1350 comprises the receiving surface of a growth medium, such as agar, provided in impactor base 1300. Viable biological particles collected on the impact surface, for example, can subsequently be grown and evaluated to provide an analysis of the composition of the fluid flow sampled. For collection of biological particles on the impact surface, control over the distance between the intake aperture 1220 and the impact surface 1350 is important. If the distance is too large, for example, the particles may sufficiently follow the fluid path so as to avoid impact with the impact surface 1350. If the distance is too small, however, the particles may impact the impact surface 1350 with a force sufficient to render the particles non-viable, and therefore unable to reproduce.

FIG. 3C shows a perspective view of selectively removable cover 1100. FIG. 3D shows a bottom view selectively removable cover 1100. FIG. 3E shows a cross sectional view of the selectively removable cover 1100. Selectively removable cover 100 includes first and second cover magnets 1155, 1150 fixed to the center underside of cover 100 and separated by spacer 1158. First cover magnet 1155 may be configured to engage with a magnetic engagement mechanism of a robotic arm to remove the removable cover 1100 from the sampling head 1100 and/or replace the removable cover 1100 to the sampling head 1100.

Selectively removable cover 1100 also includes an O-ring groove 1120 on the underside of cover 1100 proximal the outer edge. O-ring groove 1120 is configured to receive O-ring 1110. Second cover magnet 1150 magnetically engages with sampling head magnet 1250 to compress O-ring 1110. Thus, the cover 1100 may form an air tight seal with sampling head 1200.

### Example 2—Robotic Sampling System with Substantially Horizontal Rotational Axis and Configured to Mount Through a Vertical Wall

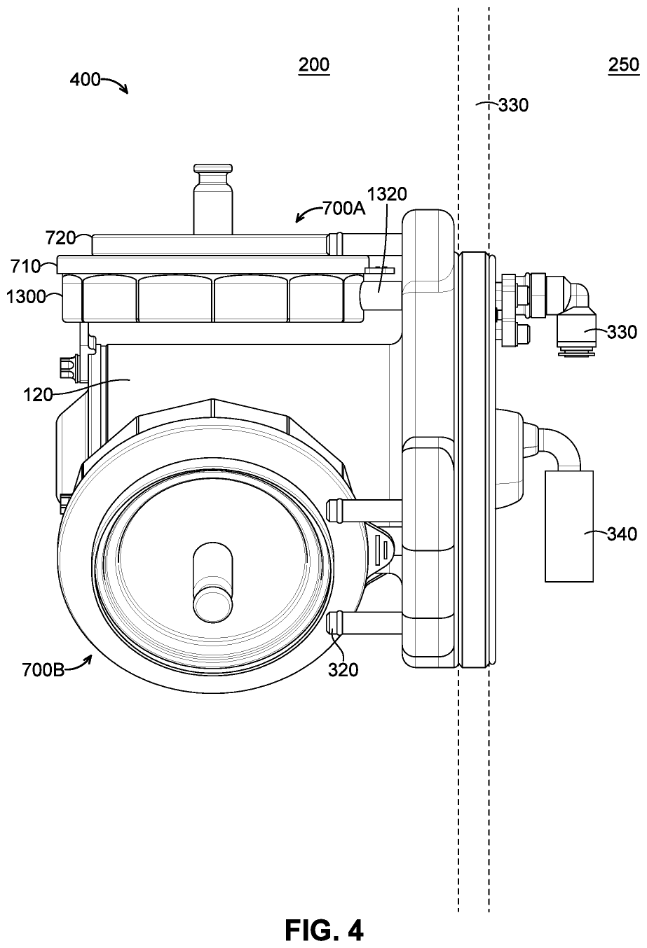

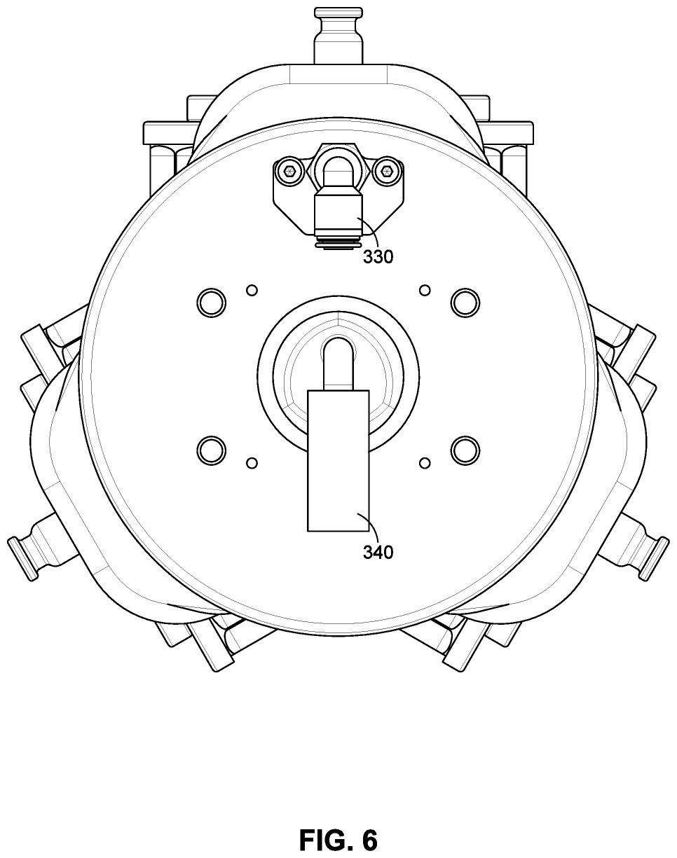

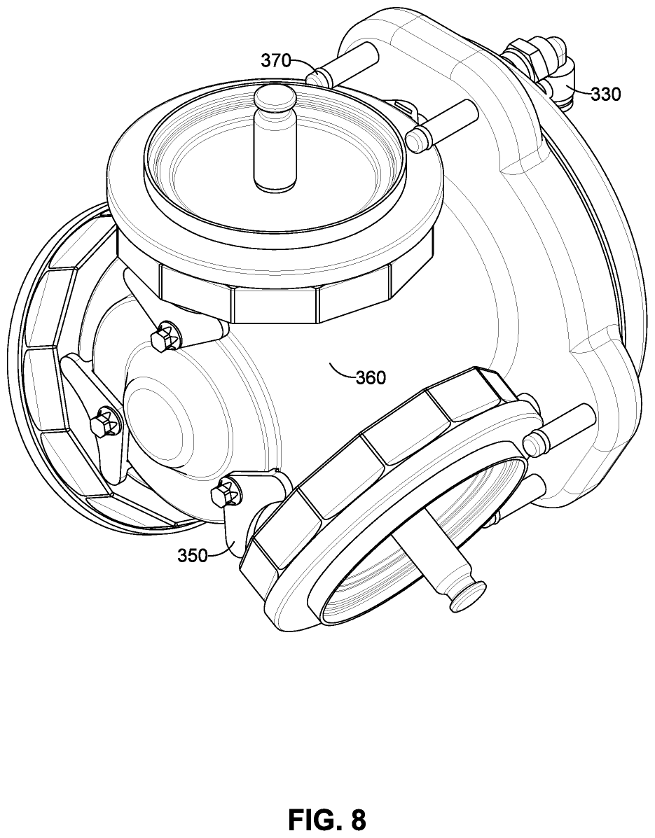

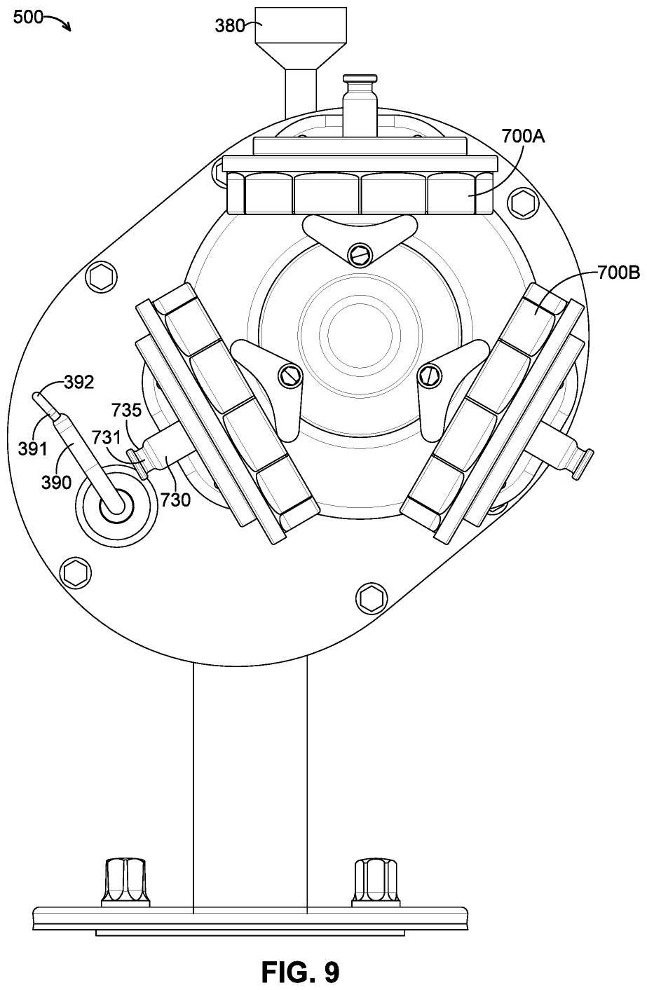

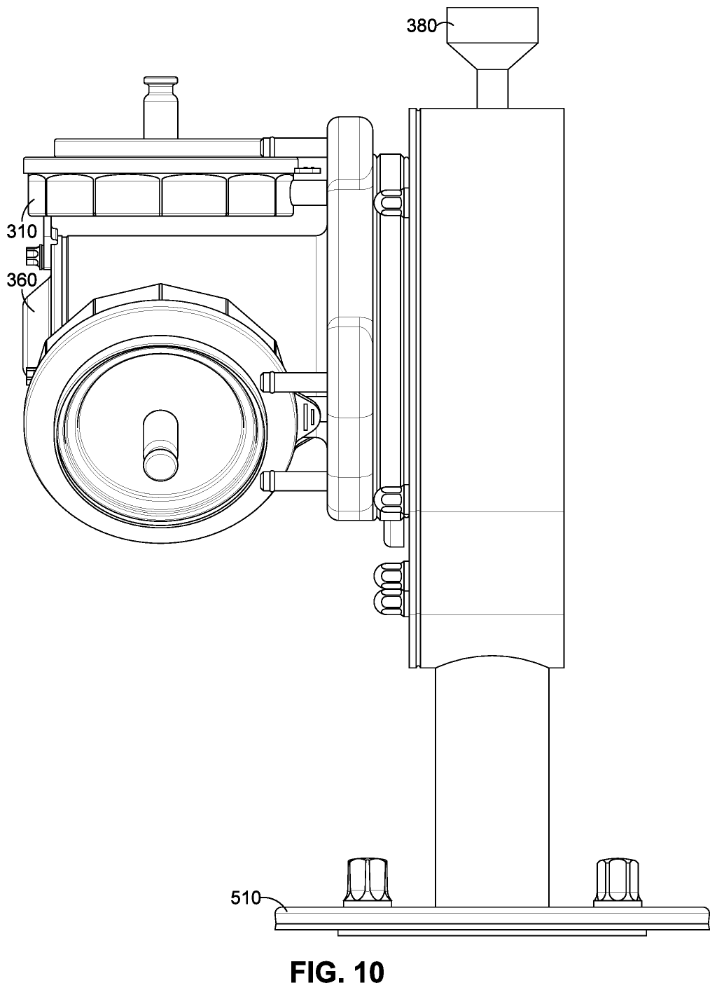

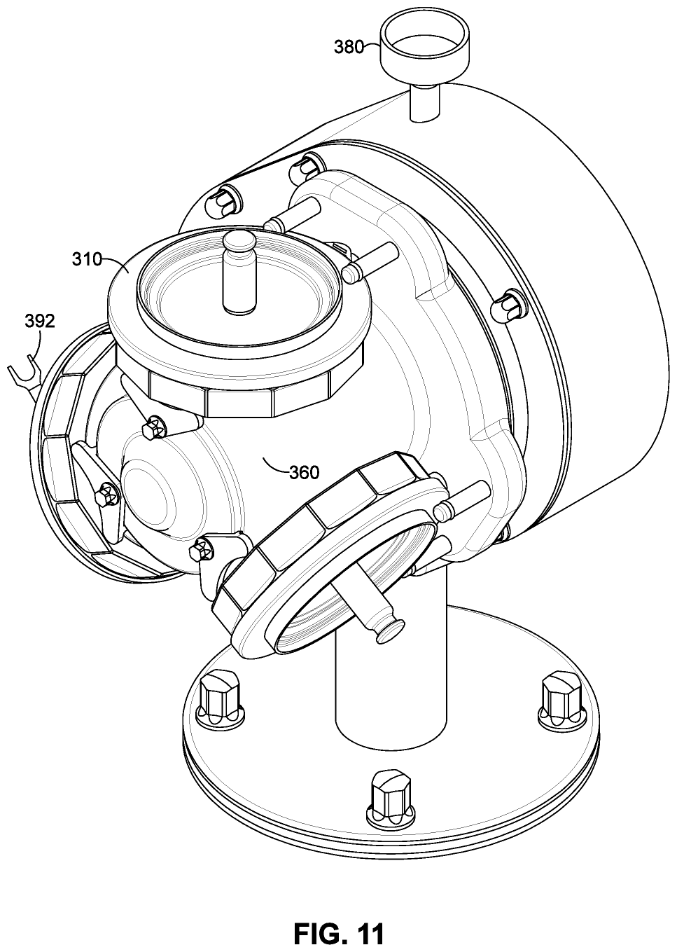

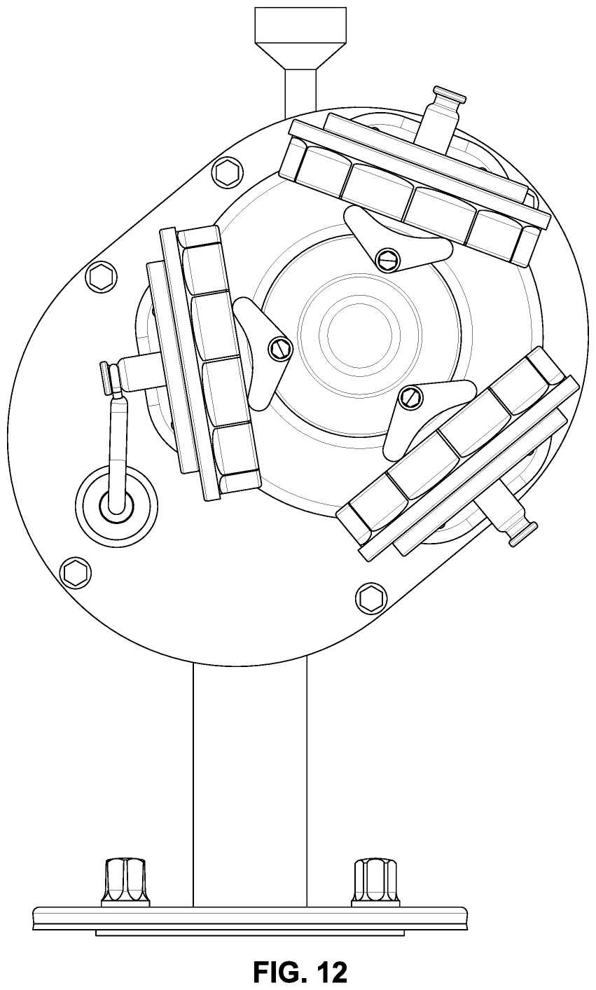

Turning now to FIGS. 4-8, a second embodiment of a robotic sampling system 400 is shown. The robotic sampling system 400 may be configured to be mounted through a wall 330 of enclosure 200. System 400 includes a plurality of impactors 700. Each impactor 700 includes comprises a sampling head 710, a selectively removable cover 720 and an impactor base 1300. System 400 may further include a robotic arm, such as the one illustrated in FIGS. 10-15. The robotic arm of system 400 may be mounted through wall 330. The sampling head 710 includes a lever 730 configured to facilitate the removal of the selectively removable cover 720 via a robotic arm 390. The lever 730 includes a groove 735 configured to engage with a gripping element 392 of the robotic arm 390. The gripping element 392 may include a magnet 391 disposed therein. Additionally or alternatively, the gripping element 392 may include a forked structure. For example the gripping element 392 may include a pair of tines configured to engage with the groove 735, one tine on each side of the lever 730.

The sampling head 710 and the selectively removable cover 720 engage via compressible sealing member 1110. The impactor 700 is configured to compress the compressible sealing member 1110 via friction fit between sampling head 710 and the selectively removable cover 720. The sampling head 710 and the impactor base 1300 engage via compressible sealing member 1210.

The sampling head 710 includes a plurality of intake apertures 1220 for sampling a fluid flow containing particles. The impactor base 1300 includes an outlet 1320 and an impact surface 1350. In operation, gas flow is directed through the intake apertures 1220 of the sampling head 710 where it is accelerated towards the impact surface 1350, and out the outlet 1320 which forces the gas to rapidly change direction. Due to their momentum, particles entrained in the gas flow are unable to make the rapid change in direction and impact on the impact surface 1350.

In embodiments, impact surface 1350 comprises the receiving surface of a growth medium, such as agar, provided in impactor base 1300. Viable biological particles collected on the impact surface, for example, can subsequently be grown and evaluated to provide an analysis of the composition of the fluid flow sampled. For collection of biological particles on the impact surface, control over the distance between the intake aperture 1220 and the impact surface 1350 is important. If the distance is too large, for example, the particles may sufficiently follow the fluid path so as to avoid impact with the impact surface 1350. If the distance is too small, however, the particles may impact the impact surface 1350 with a force sufficient to render the particles non-viable, and therefore unable to reproduce.

System 400 further includes vacuum port 330 configured to connect to a vacuum source and power and control signal connector 340. As shown in FIG. 4, system 400 may be mounted through wall 330 such that impactors 700 are within the enclosure while vacuum port 330 and power and control signal connector 340 are accessible on the other side of wall 330 in non-sterile environment 250.

Selectively removable cover 720 also includes an O-ring groove 1120 on the underside of cover 1100 proximal the outer edge. O-ring groove 1120 is configured to receive O-ring 1110. Selectively removable cover 720 engages with sampling head 710 to compress O-ring 1110. Thus, the cover 720 may form an air tight seal with sampling head 720.

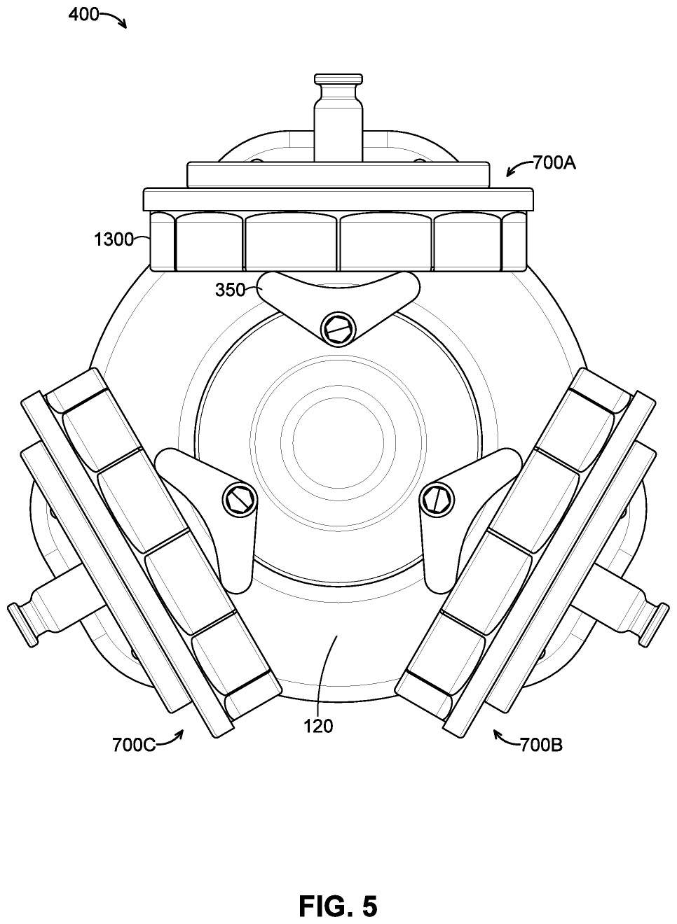

System 400 further includes rotor 120. Rotation of rotor 120 rotates impactors 700 (e.g., 700A, 700B, 700C) from a dormant pose into a sampling pose, in similar fashion as described above with respect to system 100. In FIGS. 4 and 5, impactor 700A is in a sampling pose, while impactors 700B and 700C are in a dormant pose. Rotor 120 includes supports 320, 350 to hold the impactors 700 in place.

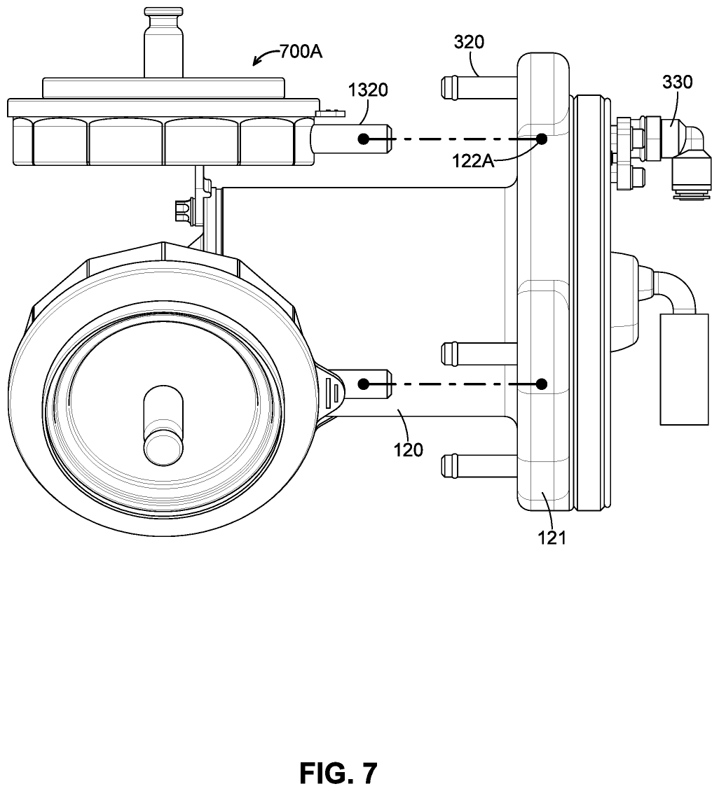

Turning now to FIG. 7, the process of loading the impactors 700 into the system is illustrated. The outlet 1320 of the impactor base of each impactor is inserted into its own receiving socket 122 (e.g., impactor 700A is inserted into receiving socket 122A) in rotor base plate 121 of the rotor 120. As can been seen, when impactor 700A, for example, is rotated into the sampling position, the outlet 1320 of impactor 700A aligns with the vacuum port 330. Accordingly, as each impactor is rotated into place, it may thereby come into fluid communication with the vacuum port 330.

### Example 3—Robotic Sampling System with Substantially Horizontal Rotational Axis and Configured to Mount to Horizontal Surface

FIGS. 10-15 show a third embodiment of a robotic sampling system 500. System 400 has many similar components and features to systems 400 and 100, described above. System 500 is configured with a base mount 510 for mounting to a horizontal surface. System 500 includes a probe 380 for sampling non-viable particles. System 500 also includes a robotic arm 390 having a gripping element 392. As previously described, each impactor 700 may include a lever 730 disposed on the selectively removable cover 720. The lever 730 may include a groove 735 configured to engage with a gripping element 392 of the robotic arm 390. Additionally or alternatively, the lever 730 may include a magnet 731 configured to engage with the magnet 391 of the robotic arm 390

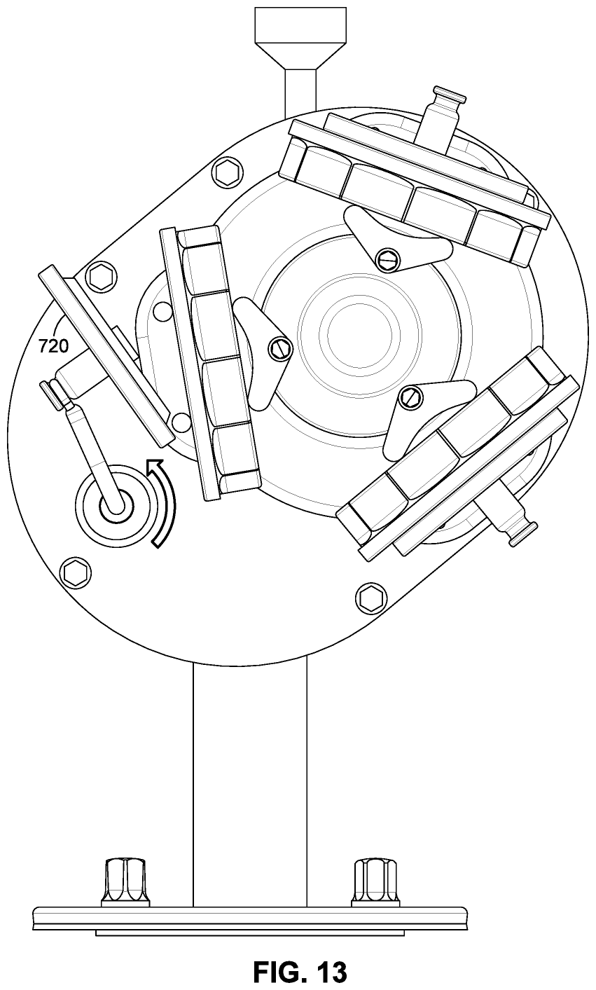

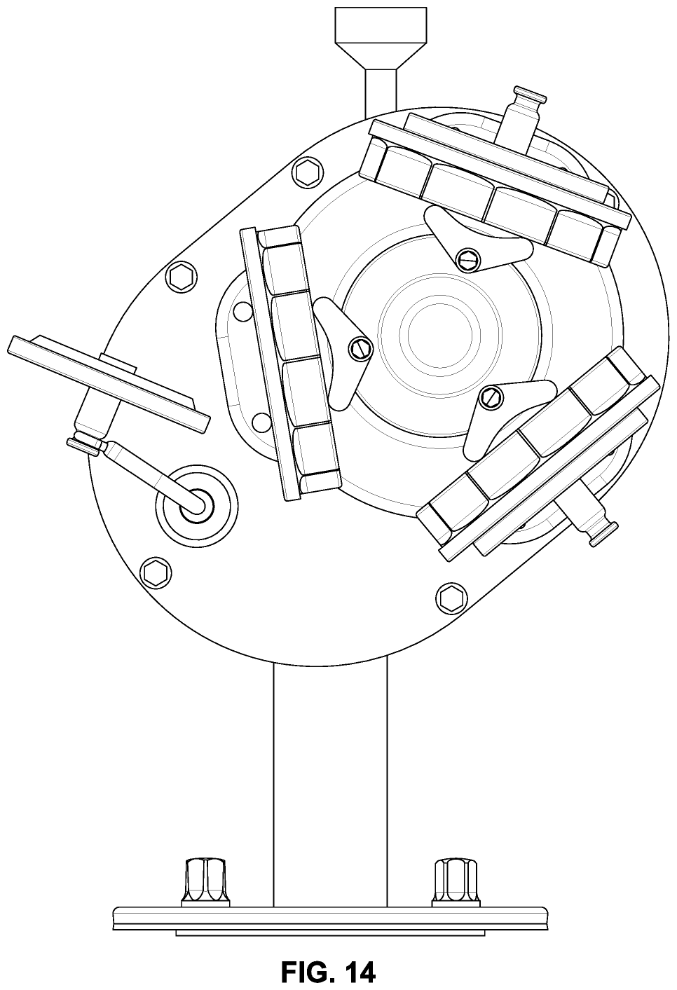

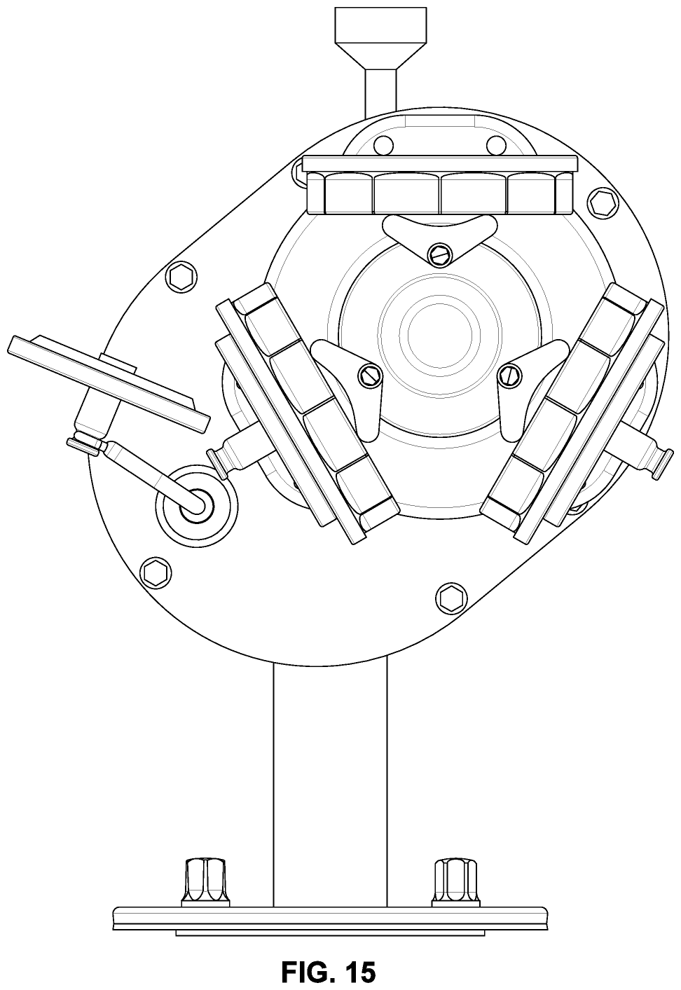

Turning to FIGS. 12-15, the process of removing the selectively removable cover and rotating an impactor from a dormant pose to a sampling pose is illustrated. First, as shown in FIG. 12, the gripping element of the robotic arm may engage with the groove of the lever. Then, as shown in FIGS. 13-14, the robotic arm may rotate in order to pry the selectively removable cover off the impactor and expose the impact surface to the environment inside the enclosure. Finally, as shown in FIG. 15, the rotor may rotate the impactor into a sampling position, thereby placing the impactor in selective communication with the vacuum system as described above.

### Example 4—Robotic Sampling System with Substantially Vertical Rotational Axis and Configured to Mount to Horizontal Surface

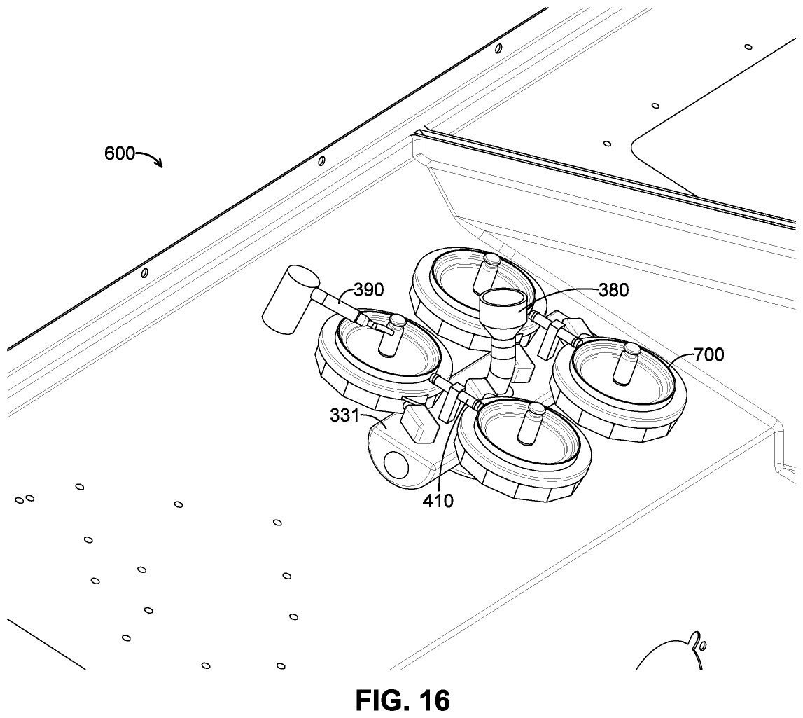

Turning to FIG. 16, a fourth embodiment of a system for robotic sampling is shown. The illustrated system 600 includes a plate holder 331, a plurality of impactors 700, an isokinetic probe 380, and a robotic arm 390. The impactors 700 are held in place by impactor retaining members 410.

In operation, the plate holder 331 rotates horizontally around its center where the fixed isokinetic probe 380 is also positioned for sampling non-viable or viable particles. As described above with respect to the other embodiments, the outlet of the impactor base of each impactor is inserted into its own receiving socket in the plate holder 331. When an impactor is rotated into the sampling position, the outlet of the impactor aligns with a vacuum port in the plate holder. Accordingly, as each impactor is rotated into place, it may thereby come into fluid communication with the vacuum port. Furthermore, as described above, the gripping element of the robotic arm 390 may engage with the groove of the lever of impactor 700. Then the robotic arm may rotate in order to pry the selectively removable cover off the impactor and expose the impact surface to the environment inside the enclosure.

### Example 5—Robotic Arm

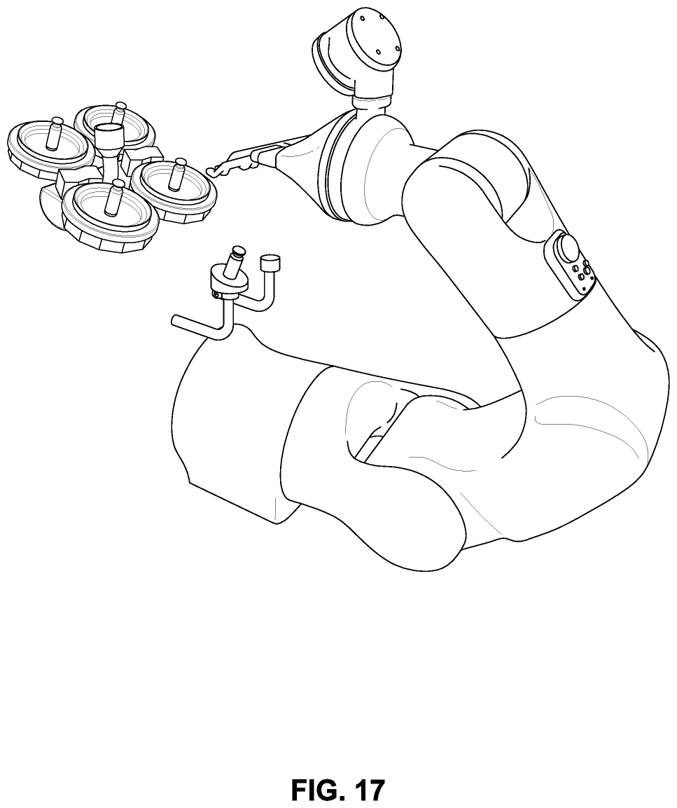

Turning to FIG. 17, one example of a robotic arm for removing and replacing the selectively removable cover is shown. In the illustrated embodiment, the robotic arm includes a gripping element comprising a forked structure.

### Example 6—Independent Sampling Flow Paths for Viable and Non-Viable Particles

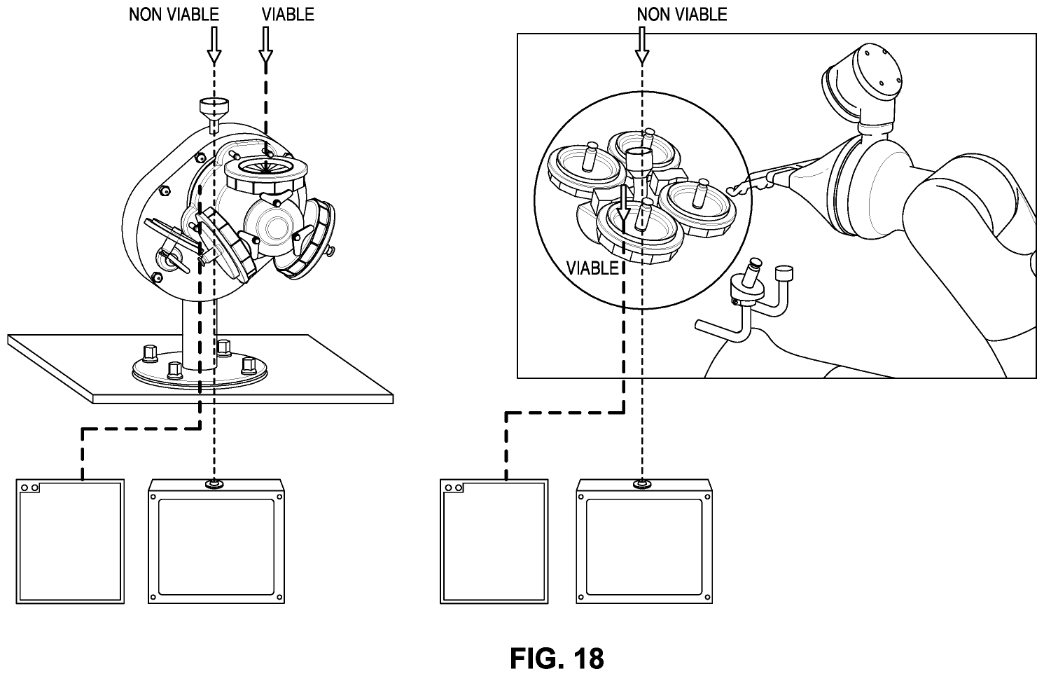

Turning to FIG. 18, two different embodiments of the sampling paths for viable and non-viable particles are shown. In the embodiment on the left, the impactors are configured to rotate in a vertical plane and the system is configured to mount to a horizontal surface. In the embodiment on the right, the impactors are configured to rotate in a horizontal plane.

### Example 7—Method of Operating Robotic Sampling System with Substantially Horizontal Rotational Axis and Configured to Mount to Horizontal Surface

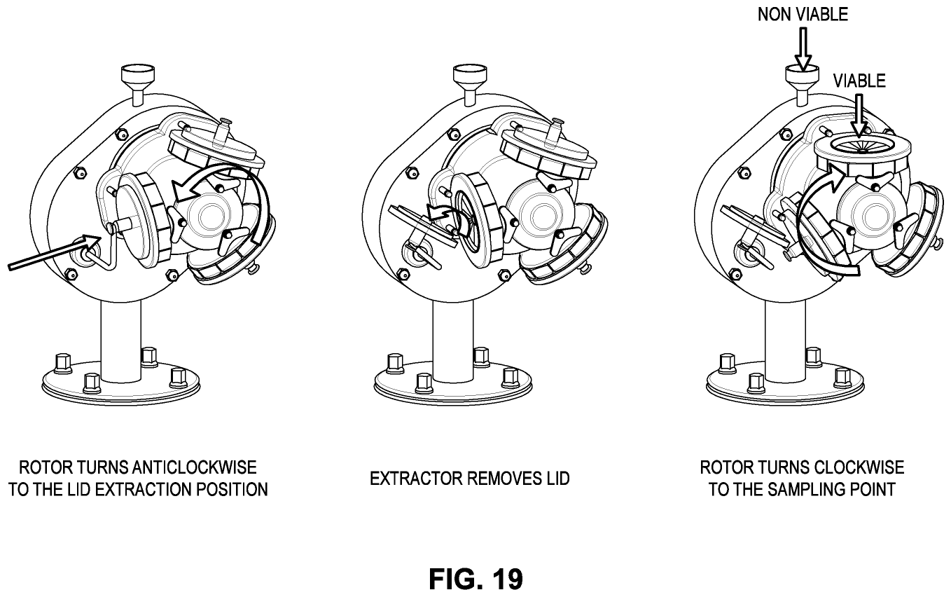

Turning now to FIG. 19, a sequence of steps for removing the selectively removable cover from an impactor via a robotic arm and rotating the impactor into a sampling pose is illustrated. In the illustrated embodiment, the rotor mechanism rotates counter-clockwise to a cover removal pose. The selectively removable cover is then removed by the robotic arm. The rotor mechanism then rotates the impactor into a sampling pose and sampling is begun.

### Example 8—Rotor Mechanism Having 5 Impactors Disposed Thereon

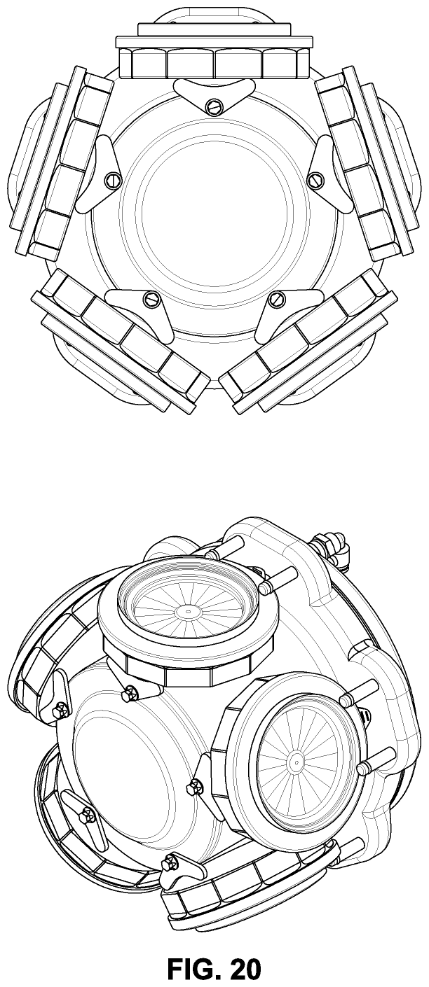

Turning now to FIG. 20, an illustration of a rotor mechanism having five impactors disposed thereon. While the illustrated embodiment has five impactors, this disclosure expressly contemplates robotic sampling systems configured for any number of impactors.

### Example 9—Apparatus for Manipulation of the Selectively Removable Cover by Hand

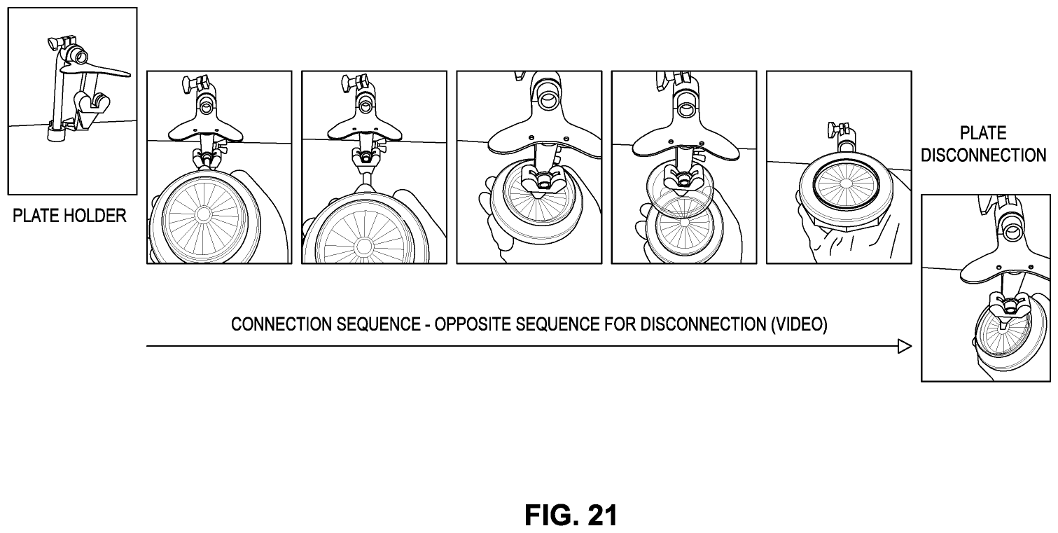

Turning now to FIG. 21, an illustration of an apparatus for removing and replacing the selectively removable cover of an impactor via one hand by a user is shown. The apparatus may have a magnet configured to magnetically engage with a magnet of a selectively removable cover of an impactor.

### Example 10—Mobile Robotic Platform

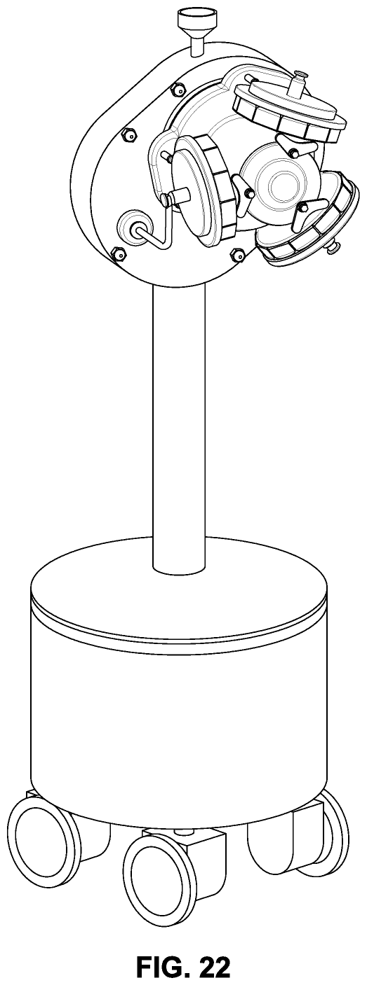

Turning now to FIG. 22, an illustration of a robotic sampling system including a mobile robotic platform is shown. The system may include one or more of the features discussed above. Furthermore, the mobile robotic platform may include a navigation system and a robotic transport system. In some embodiments, the combination of the navigation system and the robotic transport system may allow for autonomous movement in a clean room environment. The robotic sampling system may include one or more robotic arms for manipulating the impactors.

### Example 11—Navigation of the Mobile Robotic Platform

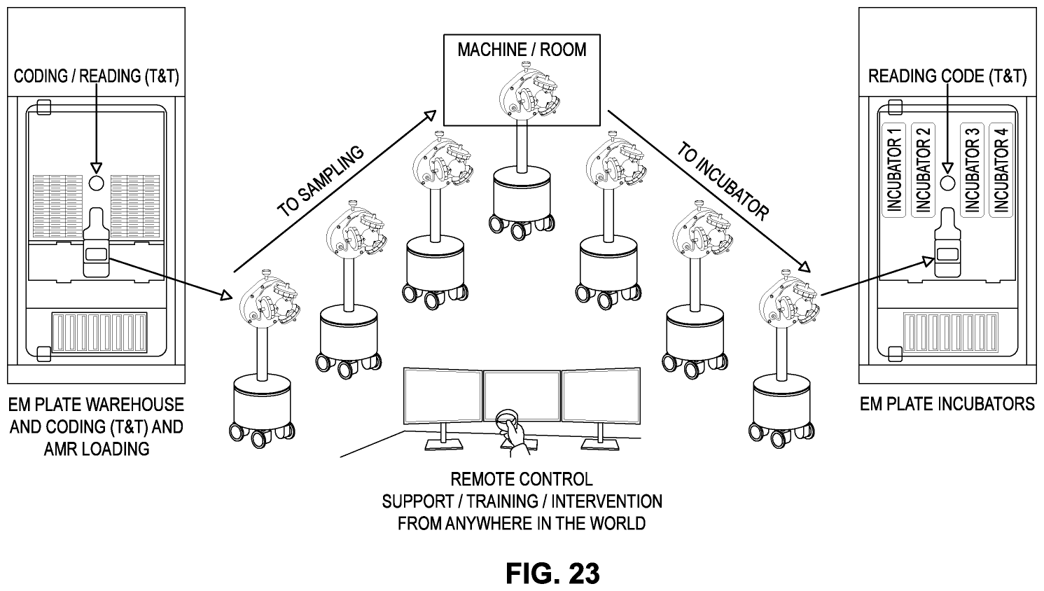

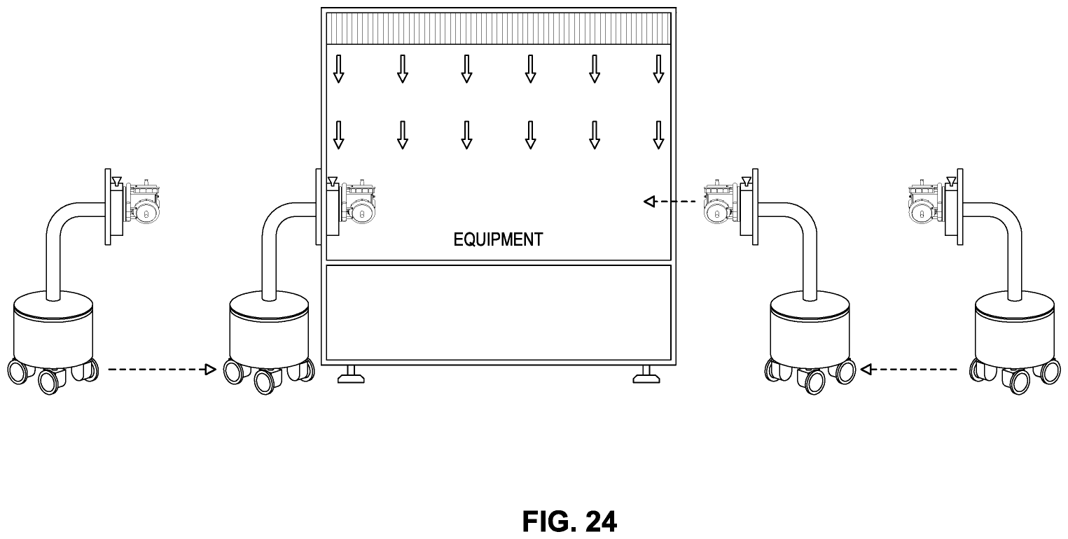

Turning now to FIGS. 23-24 an illustration of the navigation of the mobile robotic platform throughout a manufacturing facility is show. In the illustrated embodiment, the mobile robotic platform may transport the robotic sampling system to impactor dispensing station where it receives unused impactors from an impactor dispensing station. The mobile robotic platform may then transport the robotic sampling system to a sampling location for sampling. The system may remove a selectively removable cover from an impactor, rotate the impactor into a sampling pose and begin sampling. After once or more samples have been collected via the impactors, the system may navigate to a incubator station and transfer the used impactors to the incubator station. The incubator station may then incubate the impactors to determine the presence of viable particles.

Turning now to FIG. 24, the mobile robotic platform may transport the robotic sampling system to an enclosure. The mobile robotic platform may then dock with the enclosure by inserting the robotic sampling system into the enclosure via a port designed to receive the robotic sampling system. The sampling system may then take one more samples from inside the enclosure while the mobile robotic platform remains outside the enclosure.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, and methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. Nothing herein is to be construed as an admission that the invention is not entitled to antedate such disclosure by virtue of prior invention.

Every combination of components described or exemplified herein can be used to practice the invention, unless otherwise stated.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A robotic sampling system for sampling particles within an enclosure, the system comprising:
an impactor for holding a growth medium, the impactor comprising:
a sampling head comprising one or more intake apertures for sampling a stream of air and/or other gases inside the enclosure;
an impactor base containing a growth medium for receiving particles from the stream of air and/or other gases, the growth medium having an impact surface for receiving particles from the stream of air and/or other gases;
a selectively removable cover for covering the one or more intake apertures; and
an outlet for exhausting the stream of air and/or other gases; and
a robotic manipulator system configured to rotate the impactor from a dormant pose into a sampling pose.

2. The system of claim 1, comprising a plurality of impactors.

3. The system of claim 1, wherein the selectively removable cover includes a magnet configured to magnetically engage with the robotic manipulator system.

4. The system of claim 3, wherein the robotic manipulator system is configured to remove the selectively removable cover via the magnet.

5. The system of claim 3, wherein the robotic manipulator system is configured to replace the selectively removable cover via the magnet.

6. The system of claim 1, comprising a robotic arm, and:
wherein the robotic arm includes a magnetic engagement mechanism to engage with the magnetic of the selectively removable cover; or
configured to robotically remove used impactors from the robotic manipulator system and robotically replace them with new impactors.

7-8. (canceled)

9. The system of claim 2, wherein the robotic manipulator system is configured to:
(i) rotate a first impactor of the plurality of impactors from a sampling pose to a dormant pose; and
(ii) rotate a second impactor of the plurality of impactors from a dormant pose to a sampling pose.

10. (canceled)

11. The system of claim 9, wherein the sampling pose of the first impactor is the same as sampling pose of the second impactor.

12. The system of claim 1, wherein the system is configured to rotate the impactor along a trajectory tracing a portion of, or a complete circle.

13. The system of claim 12, wherein the circle has a diameter selected from the range of 2 cm to of 1000 cm; and wherein:
the robotic manipulator system rotates the impactor from a dormant pose into a sampling pose, the impactor has a trajectory characterized by an arc having an arc length selected from 10° to 180°; or
the robotic manipulator is configured to provide a trajectory for the sampler(s) having a tolerance for reproducibility of the arc length of less than 30% of the arc length.

14-15. (canceled)

16. The system of claim 1, wherein the rotation occurs about a horizontal axis.

17. The system of claim 1, wherein the rotation occurs about a vertical axis.

18. The system of claim 1, wherein the impact surface is oriented horizontally when the impactor is in the sampling position.

19. The system of claim 1, wherein the impact surface is oriented vertically when the impactor is in the dormant position.

20. The system of claim 1 comprising a flow system for flowing the fluid through the particle detection device.

21. The system of claim 20, wherein the flow system is coupled to the outlet of the sampling impactor.

22. The system of claim 2 comprising a rotor mechanism, wherein the rotor mechanism is configured to engage the plurality of impactors disposed thereon, the impactors being oriented around a rotational axis of the rotor mechanism, wherein the rotor mechanism is configured to rotate about the rotational axis.

23. (canceled)

24. The system of claim 22, wherein the rotational axis is within 10 degrees of horizontal.

25. (canceled)

26. The system of claim 22, wherein:
each impactor has a bottom surface, opposite the impact surface; and
each impactor is disposed on the rotor mechanism such that the bottom surface of each impactor is oriented toward the rotational axis.

27. The system of claim 22, wherein when an impactor is rotated into the sampling pose, the impact surface of the impactor is substantially horizontal and facing upwards, and the impactor is located at a highest point on a rotational path traced by the rotor mechanism.

28. The system of claim 22, wherein when an impactor is rotated into a dormant position, the impact surface of the impactor is not substantially horizontal and/or not facing upwards.

29. (canceled)

30. The system of claim 22, wherein the rotational axis is within 10 degrees of vertical.

31. (canceled)

32. The system of claim 22, wherein:
the impact surface of each impactor remains substantially horizontal as it is rotated from dormant position to a sampling position by the rotor mechanism.

33. The system of claim 22, wherein the plurality of impactors are disposed on the rotor mechanism such that each impactor traces the same rotational path, the rotational path defining a substantially horizontal plane.

34-35. (canceled)

37. The system of claim 1, wherein the impactor base, sampling head, or both are optically transparent so as to allow visualization, optical detection or imaging of particles comprising viable biological particles in the growth medium without physically accessing the growth medium.

38-40. (canceled)

41. The system of claim 1 comprising a mobile robotic platform, wherein the robotic manipulator system is mounted to the mobile robotic platform.

42. The system of claim 41, wherein mobile robotic platform comprises:
a navigation system; and
a robotic transport system;
wherein the navigation system is configured to direct the robotic transport system to move the robotic sampling system from a sampling location to an incubator station.

43. The system of claim 41, wherein mobile robotic platform comprises:
a navigation system; and
a robotic transport system;
wherein the navigation system is configured to direct the robotic transport system from an impactor dispensing station to a sampling location.

44. A method of sampling particles within an enclosure, the method comprising:
rotating an impactor from a dormant pose into a sampling pose via a robotic manipulator system;
removing a selectively removable cover covering one or more intake apertures of the impactor; and
sampling a stream of air and/or other gases from within or from the enclosure via the impactor, the sampling comprising:
intaking the stream of air and/or other gases via a sampling head comprising the one or more intake apertures;
impacting particles from the stream of air and/or other gases onto an impact surface of a growth medium in an impactor base of the impactor; and
exhausting the stream of air and/or other gases from the impactor via an outlet of the impactor.

45. A method of controlling a robotic sampling system for sampling of particles within an enclosure, the method comprising:
providing first instructions to a robotic manipulator system, the first instructions configured to cause the robotic manipulator system to rotate an impactor from a dormant pose into a sampling pose;
providing second instructions to the robotic manipulator system, the second instructions configured to cause the robotic manipulator system to remove a selectively removable cover form the impactor; and
providing third instructions to a fluid actuation system, the third instructions configured to cause the fluid actuation system to intake air and/or other gases from the enclosure into the impactor.
